(19) United States
(12) Patent Application Publication
(10) Pub. No.: US 2025/0222406 A1
(43) Pub. Date: Jul. 10, 2025

(54) METHODS OF PROCESSING BRINE COMPRISING LITHIUM

(71) Applicant: BL Technologies, Inc., Minnetonka, MN (US)

(72) Inventors: Zamir ALAM, Burlington (CA); Nivarutti Dagadu PATIL, Bangalore (IN); Monica SHARMA, Bangalore (IN)

(21) Appl. No.: 18/851,530

(22) PCT Filed: Apr. 5, 2023
(86) PCT No.: PCT/US2023/017593

§ 371 Date: Sep. 26, 2024

(30) Foreign Application Priority Data
Apr. 11, 2022 (IN) 202211021642

(51) Int. Cl. B01D 61/58; B01D 61/00; B01D 61/02; C02F 1/44; C02F 101/10; C22B 3/22; C22B 26/12

(52) U.S. Cl. CPC B01D 61/58; B01D 61/005; C02F 1/442; C02F 1/445; C22B 3/22; C22B 26/12; B01D 61/0021; B01D 61/0271; B01D 2317/025; C02F 2101/10; C02F 2301/046; C02F 2301/08

(57) ABSTRACT

A method of processing brine comprising lithium. The method may include providing a feed brine and a draw brine to a first forward osmosis (FO) module, the feed brine and/or the draw brine comprising lithium, and forming a feed brine concentrate and a dilute draw brine; and providing the dilute draw brine to a first nanofiltration (NF) module, and forming a first NF retentate, at least a portion of which is optionally recycled to the FO module, and forming a first NF permeate comprising at least a portion of the lithium. The method may additionally include providing a first brine to an initial NF module that is upstream of the first FO module, and forming the feed brine that is provided to the FO module, and forming an initial NF retentate, at least a portion of which is optionally recycled to the first FO module and/or the first NF module.

### FIELD

This specification relates to membrane-based methods for processing brine comprising lithium, such as high total dissolved solids brines comprising lithium.

### BACKGROUND

The following paragraphs are not an admission that anything discussed in them is prior art or part of the knowledge of persons skilled in the art.

Demand for lithium around the world has increased, and is expected to continue to increase due to its various uses across a number of industries, including its use in batteries, ceramics, chemical additives, and nuclear applications. Of these, use in the production of batteries, such as lithium-ion batteries, contributes to some of the highest consumption of lithium.

The world's lithium supply is largely found and extracted from subsurface brines that can comprise upwards of about 100 to 1,400 mg/L, or more, of lithium. Commercial processes for extracting lithium from brine may include evaporation in large ponds, followed by precipitation, leaching, or absorption processes to extract the lithium from the brine. Such processes can require months or years to complete, and may recover only a percentage of the lithium in the brine.

### Introduction

The following introduction is intended to introduce the reader to this specification but not to define any invention. One or more inventions may reside in a combination or sub-combination of the features described below or in other parts of this document. The inventors do not waive or disclaim their rights to any invention or inventions disclosed in this specification merely by not describing such other invention or inventions in the claims.

Demand for lithium continues to increase; for example, for battery manufacturing. However, challenges exist with processing of lithium from different sources. For example, the Salars in South America are among some of the major sources of lithium globally. Generally, isolating lithium from the Salar brines involves evaporation (for example, solar evaporation) to reduce brine volume, which triggers a precipitation of salts that removes impurities such as divalent ions. However, such processes can be time consuming, and can result in only about 40-50% of the lithium being recovered due to loss of lithium (i) via co-precipitation with divalent ions (Ca²⁺, Mg²⁺, SO₄²⁻) or with boron, and/or (ii) during further processing of the evaporated brine.

Moreover, it has been found that the incumbent evaporation and precipitation processes tend not to remove enough of the divalent ions during precipitation to reduce their concentrations to sufficiently low levels for further, membrane-based processing. For example, following evaporation and precipitation, the divalent ion concentrations in the remaining brines are often too high for nano-filtration (NF) membrane-based processes. Many incumbent nano-filtration membranes cannot operate when sulfate (SO₄²⁻) concentrations exceed about 30,000 ppm, and/or magnesium (Mg²⁺) concentrations exceed about 20,000 or 30,000 ppm, and/or calcium (Ca²⁺) concentration exceeds about 1000 or 1500 ppm. To treat brines with such high divalent ion concentrations via membrane-based processes, the osmotic pressure requirement is often >1200 Psi. However, nano-filtration membranes tend to be limited in terms of their operating pressures, based on the osmotic pressure of their feed brine streams. When the osmotic pressure of the NF feed brine stream exceeds the allowable or operational limits of the nano-filtration membrane due to divalent ion concentrations, it becomes practically impossible to use nano-filtration to remove divalent ions from feed brines. As such, further purification is often necessary, and these subsequent purification processes can result in a loss of lithium, leading to reduced recovery.

To minimize or avoid loss of lithium due to co-precipitation and/or un-treatable brines, the brines may be diluted to make them more treatable via membrane-based processes. However, the location of lithium sources can make this difficult. For example, due to drought climate conditions at salar ponds sites in Latin America, there is minimal availability of water for dilution. Some solutions considered have included direct lithium extraction (DLE) based technology, a sorption-desorption process for lithium purification. DLE generates an eluent that can be very dilute, and may need further processing like nano-filtration and/or reverse osmosis (RO) and/or thermal evaporation to concentrate it. However, RO has some of its own challenges, such as a TDS limitation (<1 lakh ppm), and higher power consumption which increases with feed TDS.

In an aspect of the present disclosure, there is provided method of processing brine comprising lithium.

In one or more examples of the present disclosure, the method comprises providing a feed brine and a draw brine to a first forward osmosis (FO) module, the feed brine and/or the draw brine comprising lithium, and forming a feed brine concentrate and a dilute draw brine. The dilute draw brine is provided to a first nanofiltration (NF) module, forming a first NF retentate and a first NF permeate comprising at least a portion of the lithium. At least a portion of the first NF retentate may be recycled to the FO module.

In one or more examples, the method further comprises providing a first brine to an initial NF module that is upstream of the first FO module, from which is formed the feed brine that is provided to the first FO module. An initial NF retentate is also formed, at least a portion of which is optionally recycled to the first FO module and/or the first NF module.

In one or more examples, the method further comprises providing the first NF permeate to a second NF module downstream of the first NF module, and forming a second NF permeate comprising at least a portion of the lithium; and forming a second NF retentate, at least a portion of which is optionally recycled upstream and/or downstream of the second NF module. The method may further comprise providing the second NF permeate to one or more subsequent NF modules downstream of the second NF module, from which are formed a subsequent NF permeate comprising at least a portion of the lithium, and a subsequent NF retentate. At least a portion of the subsequent NF retentate may be recycled upstream and/or downstream of the one or more subsequent NF modules.

In one or more examples, the method further comprises providing the feed brine concentrate as a feed solution to a second FO module downstream of the first FO module, and providing a first draw solution to the second FO module, at least a portion of the first draw solution being optionally recycled from upstream of the second FO module. From the second FO module is formed a first FO concentrate comprising at least a portion of the lithium, and a first FO diluted draw, at least a portion of which is optionally recycled to an NF module upstream and/or downstream of the second FO module. The method may further comprise providing the first FO concentrate to one or more subsequent FO modules downstream of the second FO module, and providing a second draw solution to the one or more subsequent FO modules. At least a portion of the second draw solution may be recycled from upstream of the one or more subsequent FO modules. From the one or more subsequent FO module is formed a subsequent FO concentrate comprising at least a portion of the lithium, and a subsequent FO diluted draw, at least a portion of which is optionally recycled to an NF module upstream and/or downstream of the one or more subsequent FO modules.

In one or more examples, where the method comprises providing a feed brine to the first FO module, a first brine is provided to the first NF module, forming the first NF permeate that is the feed brine provided to the first FO module, and forming the first NF retentate that is the draw brine, at least a portion of which is provided to the first FO module.

In one or more examples of the present disclosure, the draw brine comprises lithium.

In one or more examples of the present disclosure, the feed brine comprises lithium.

In one or more examples of the present disclosure, the feed brine and the draw brine comprise lithium.

In one or more examples of the present disclosure, the first brine comprises lithium.

In one or more examples, the methods as described herein may (i) allow treatment of higher total dissolved solids (TDS) brines comprising lithium, which would not otherwise be treatable by membranes-based processes due to their high solids concentrations and/or high osmotic pressures; (ii) allow for dilution of higher TDS brines comprising lithium via on-site water generation; (iii) allow concentration of brines comprising lithium that comprise higher concentrations of divalent ions, and thus have a higher osmotic pressure; (iv) allow at least partial purification of brines comprising lithium; (v) allow for replacement of energy-intensive, TDS-restricted membrane-based processes (for example, reverse osmosis processes) for concentrating lower TDS brines comprising lithium; (vi) allow processing of waste streams for recovery of lithium that would otherwise be unrecoverable; and/or (vii) a combination thereof.

In one or more examples, the methods as described herein may (i) improve overall lithium recoveries and/or yields; (ii) reduce lithium loss generally experienced when using at least some of the incumbent processes; (iii) allow lithium recovery from the brines which would otherwise be left as a waste product; and/or (iv) use brines already available on-site, such as in the Salars.

### BRIEF DESCRIPTION OF THE FIGURES

Embodiments of the present disclosure will now be described, by way of example only, with reference to the attached Figures.

FIG. 1 depicts a schematic flow diagram of a method for processing brine comprising lithium, the method comprising nano-filtration and forward osmosis.

FIG. 2 depicts a schematic flow diagram of a method for processing brine comprising lithium, the method comprising an initial nano-filtration step, a first forward osmosis step, and a first nano-filtration step.

FIG. 3 depicts a schematic flow diagram of a method for processing brine comprising lithium, the method comprising (A) an initial nano-filtration step, a first forward osmosis step, a first nano-filtration step, and a second nano-filtration step; and (B) an initial nano-filtration step, a first forward osmosis step, a first nano-filtration step, a second nano-filtration step, and subsequent nano-filtration steps.

FIG. 4 depicts a schematic flow diagram of a method for processing brine comprising lithium, the method comprising (A) an initial nano-filtration step, a first forward osmosis step, a first nano-filtration step, and a second forward osmosis step; and (B) an initial nano-filtration step, a first forward osmosis step, a first nano-filtration step, a second forward osmosis step, and subsequent forward osmosis steps.

FIG. 5 depicts a schematic flow diagram of a method for processing brine comprising lithium, the method comprising an initial nano-filtration step, a first forward osmosis step, a first nano-filtration step, a second forward osmosis step, and subsequent forward osmosis steps; and a second nano-filtration step, and subsequent nano-filtration steps.

FIG. 6 depicts a schematic flow diagram of an exemplified method for processing brine comprising lithium, the method comprising an initial nano-filtration step, a first forward osmosis step, and a first nano-filtration step.

FIG. 7 graphically depicts the % ion passage of divalent ions during an NF process relative to % recovery based on nano-filtration permeate.

FIG. 8 graphically depicts the water flux during an FO process relative to time.

FIG. 9 depicts a schematic flow diagram of an exemplified method for processing brine comprising lithium, the method comprising forward osmosis.

FIG. 10 depicts a schematic flow diagram of an exemplified method for processing brine comprising lithium, the method comprising first nano-filtration step, and a second nano-filtration step following forward osmosis.

FIG. 11 graphically depicts the permeate flux during a high pressure NF (1300 Psi) process relative to % recovery based on permeate.

FIG. 12 depicts a schematic flow diagram of another exemplified method for processing brine comprising lithium, the method comprising an initial nano-filtration step, a first forward osmosis step, and a first nano-filtration step.

FIG. 13 depicts a schematic flow diagram of an exemplified method for processing brine comprising lithium, the method comprising an initial nano-filtration step, a first forward osmosis step, a first nano-filtration step, and a second forward osmosis step.

FIG. 14 depicts a schematic flow diagram of an exemplified method for processing brine comprising lithium, the method comprising nano-filtration and forward osmosis.

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein refers to the list following being non-exhaustive, and may or may not include any other additional suitable items, for example one or more further feature(s), component(s) and/or ingredient(s) as appropriate.]

Generally, the present disclosure provides a method of processing brine comprising lithium. The method may be those discussed above or below, and may include a combination or sub-combination of the elements or method steps described above or below.

For example, a method according to the present disclosure may include providing a feed brine and a draw brine to a first forward osmosis (FO) module, the feed brine and/or the draw brine comprising lithium, and forming a feed brine concentrate and a dilute draw brine; and providing the dilute draw brine to a first nanofilitration (NF) module, and forming a first NF retentate, at least a portion of which is optionally recycled to the FO module, and forming a first NF permeate comprising at least a portion of the lithium. The method may further include providing a first brine to an initial NF module that is upstream of the first FO module, and forming the feed brine that is provided to the FO module, and forming an initial NF retentate, at least a portion of which is optionally recycled to the first FO module and/or the first NF module.

### Feed Brines

### First Brine

In one or more examples, one or more methods described herein may include a first brine.

The first brine may include any one or combination of the following features. The first brine may be free, or substantially free, of make-up water, make-up aqueous solutions, or any combination thereof. The first brine may not comprise make-up water, make-up aqueous solutions, or any combination thereof.

The first brine may comprise a total dissolved solids (TDS) of less than 250,000 mg/L; or a TDS between about 10,000 mg/L and about 250,000 mg/L or between about 10,000 mg/L and about 250,000 mg/L, such as between about 10,000 mg/L and about 240,000 mg/L, or between about 10,000 mg/L and about 100,000 mg/L or or between about 10,000 mg/L and about 50,000 mg/L or or between about 10,000 mg/L and about 40,000 mg/L or or between about 10,000 mg/L and about 30,000 mg/. The first brine may comprise lithium at a concentration of at least 10 mg/L, for example, lithium at a concentration of at least 500 mg/L; or lithium at a concentration between about 10 mg/L to about 6000 mg/L or between about 10 mg/L to about 2300 mg/L. The first brine may comprise divalent ions, such as Ca⁺², Mg⁺², SO₄⁻; or divalent ions Ca⁺², Mg⁺², and/or SO₄⁻² at concentrations of at least 40 mg Ca⁺² per L, at least 10 mg of Mg⁺² per L, and/or at least 0.1 mg of SO₄⁻² per L. The first brine may comprise divalent ions Ca⁺², Mg⁺², and/or SO₄⁻² at concentrations of about 1000 mg/L or less or 800 mg/L or less of Ca⁺²; 25,000 mg/L or less or 1300 mg/L or less of Mg⁺²; and/or 25,000 mg/L or less or 2700 mg/L or less of SO₄⁻². The first brine may also comprise divalent ions Ca⁺², Mg⁺², and/or SO₄⁻² at concentrations of about 100 to about 1000 mg/L or about 100 to about 800 mg/L Ca⁺²; or about 10 to about 60 mg/L Mg⁺², and/or about 0.1 to about 50 mg/L SO₄⁻².

The first brine may comprise a brine derived from an underground reservoir, such as a high total dissolved solid (salar brine), low total dissolved solids (TDS) geothermal brine; a sea water brine; a brine derived from a direct lithium eluent; or a combination thereof.

A high TDS brine may comprise a Latin American salar brine which comprise a TDS of about 100,000 to about 250,000 mg/L, and may comprise ions such as Na⁺, K⁺, Li⁺, Cl⁻, Ca⁺², Mg⁺², and/or SO₄⁻² at concentrations of about 12000 to about 15,000 mg Na⁺ per L, about 12000 to about 16000 mg K⁺ per L, about 3000 to about 6000 mg Li⁺ per L, about 100,000 to about 150,000 mg Cl⁻ per L, about 50 to about 1500 mg Ca⁺² per L, about 10,000 to about 25,000 mg of Mg⁺² per L, and/or about 10,000 to about 25,000 mg of SO₄⁻² per L.

A low TDS geothermal brine may comprise a Cerro Prieto geothermal brine. The Cerro Prieto geothermal brine may comprise a TDS of about 12,000 to about 40,000 mg/L, and may comprise ions such as Na⁺, K⁺, Li⁺, Cl⁻, Ca⁺², Mg⁺², and/or SO₄⁻² at concentrations of about 4000 to about 10,000 mg Na⁺ per L, about 1000 to about 3000 mg K⁺ per L, about 10 to about 13 mg Li⁺ per L, about 9000 to about 27,000 mg Cl⁻ per L, about 140 to about 800 mg Ca⁺² per L, about 14 to about 60 mg of Mg⁺² per L, and/or about 0.1 to about 34 mg of SO₄⁻² per L.

A sea water brine may comprise a TDS of less than about 40,000 to about 50,000 mg/L, and may comprise ions such as Li⁺, Ca⁺², Mg⁺², and/or SO₄⁻² at concentrations of <1 mg Li⁺ per L, about 400 mg Ca⁺² per L, about 1300 mg of Mg⁺² per L, and/or about 2700 mg of SO₄⁻² per L.

A brine derived from a direct lithium eluent comprise a TDS of about 10,000 to about 40,000 mg/L, and may comprise ions such as Li⁺, Ca⁺², Mg⁺², and/or SO₄⁻² at concentrations of about 100 to about 2300 mg Li⁺ per L, about 40 to about 150 mg Ca⁺² per L, about 40 to about 150 mg of Mg⁺² per L, and/or about 20 to about 200 mg of SO₄⁻² per L.

The first brine, as described herein, may comprise an osmotic pressure that is less than the osmotic pressure of a draw brine, as described herein.

### Feed Brine

In one or more examples, one or more methods described herein may include a feed brine.

The feed brine may free, or substantially free of make-up water, make-up aqueous solutions, or any combination thereof. The feed brine may not comprise make-up water, make-up aqueous solutions, or any combination thereof.

The feed brine may include any one or combination of the following features. The feed brine may comprise a total dissolved solids (TDS) of less than 250,000 mg/L or less than 50,000 mg/L; or a TDS between about 10,000 mg/L and about 100,000 mg/L or between about 10,000 mg/L and about 50,000 mg/L. The feed brine may comprise lithium at a concentration of at least 10 mg/L, for example, lithium at a concentration of at least 500 mg/L; or lithium at a concentration between about 10 mg/L to about 6000 mg/L or between about 10 mg/L to about 6000 mg/L. The feed brine may comprise divalent ions, such as Ca⁻², Mg⁺² SO₄⁻²; or divalent ions Ca⁺², Mg⁺², and/or SO₄⁻² at concentrations of at least 5 mg Ca⁺² per L, at least 3 mg of Mg⁺² per L, and/or at least 1 mg of SO₄⁻² per L. The feed brine may comprise divalent ions Ca⁺², Mg⁺², and/or SO₄⁻² at concentrations of about 5 to about 800 mg Ca⁺² per L or of about 5 to about 100 mg Ca⁺² per L, about 3 to about 10,000 mg of Mg⁺² per L or about 3 to about 50,000 mg of Mg⁺² per L, and/or about 1 to about 15,000 mg of SO₄⁻² per L or about 15 to about 15,000 mg of SO₄⁻² per L.

In one or more examples, the feed brine may be the first brine. In such examples, the feed brine may comprise a brine derived from an underground reservoir, such as a high total dissolved solids (TDS) salar brine from Latin America or a low total dissolved solids (TDS) geothermal brine. The feed brine may comprise a sea water brine. The feed brine may comprise a brine derived from a direct lithium eluent.

In one or more examples, the feed brine comprises the NF permeate following providing the first brine to an NF module. In such examples, the feed brine may be the NF permeate of a brine derived from an underground reservoir, such as a high TDS salar brine from Latin America, a low TDS geothermal brine, a sea water brine, a brine derived from a direct lithium eluent, or a combination thereof, as provided to an NF module.

A high TDS brine may comprise a Latin American salar brine which comprise TDS of about 100,000 to about 250,000 mg/L, and may comprise ions such as Na⁺, K³⁰, Li⁺, Cl⁻, Ca⁺², Mg⁺², and/or SO₄⁻² at concentrations of about 12000 to about 15,000 mg Na⁺ per L, about 12000 to about 16000 mg K⁺ per L, about 3000 to about 6000 mg Li⁺ per L, about 100,000 to about 150,000 mg Cl⁻ per L, about 50 to about 1500 mg Ca⁺² per L, about 10,000 to about 25,000 mg of Mg⁺² per L, and/or about 10,000 to about 25,000 mg of SO₄⁻² per L.

A low TDS geothermal brine may comprise a Cerro Prieto geothermal brine. The Cerro Prieto geothermal brine may comprise a TDS of about 12,000 to about 40,000 mg/L, and may comprise ions such as Na⁺, K⁺, Li⁺, Cl⁻, Ca⁺², Mg⁺², and/or SO₄⁻² at concentrations of about 4000 to about 10,000 mg Na⁺ per L, about 1000 to about 3000 mg K⁺ per L, about 10 to about 13 mg Li⁺ per L, about 9000 to about 27,000 mg Cl⁻ per L, about 140 to about 800 mg Ca⁺² per L, about 14 to about 60 mg of Mg⁺² per L, and/or about 0.1 to about 34 mg of SO₄⁻² per L.

A sea water brine may comprise a TDS of less than about 40,000 to about 50,000 mg/L, and may comprise ions such as Li⁺, Ca⁺², Mg⁺², and/or SO₄⁻² at concentrations of <1 mg Li⁺ per L, about 400 mg Ca⁺² per L, about 1300 mg of Mg⁺² per L, and/or about 2700 mg of SO₄⁻² per L.

A brine derived from a direct lithium eluent comprise a TDS of about 10,000 to about 40,000 mg/L, and may comprise ions such as Li⁺, Ca⁺², Mg⁺², and/or SO₄⁻² at concentrations of about 100 to about 2300 mg Li^{t} per L, about 40 to about 150 mg Ca⁺² per L, about 40 to about 150 mg of Mg⁺² per L, and/or about 20 to about 200 mg of SO₄⁻² per L.

The feed brine, as described herein, may comprise an osmotic pressure that is less than the osmotic pressure of a draw brine, as described herein.

### Draw Brines

In one or more example, one or more methods described herein include a draw brine.

The draw brine may free, or substantially free of make-up water, make-up aqueous solutions, or any combination thereof. The draw brine may not comprise make-up water, make-up aqueous solutions, or any combination thereof. The draw brine may comprise a total dissolved solid concentration that precludes treatment via nanofiltration, zero liquid discharge (ZLD) processes, minimum liquid discharge (MLD) processes, or others, in the absence of dilution.

The draw brine may include any one or combination of the following features. The draw brine may include a total dissolved solids (TDS) of at least 100,000 mg/L; or a TDS between about 100,000 mg/L and about 1,000,000 mg/L, such as between about 400,000 mg/L and about 800,000 mg/L. The draw brine may comprise lithium at a concentration of at least 1 mg/L, or at least 10 mg/L, or at least 100 mg/; or lithium at a concentration between about 100 to about 10,000 mg/L, or about 6000 mg/L to about 8000 mg/L.

The draw brine may comprise divalent ions, such as Ca²⁺, Mg²⁺, SO₄²⁻; or divalent ions Ca²⁺, Mg²⁺, and/or SO₄²⁻ at concentrations of at least 300 mg Ca²⁺ per L, at least 1000 mg of Mg²⁺ per L, and/or at least 500 mg of SO₄²⁺ per L. The draw brine may comprise about 1,000 mg/L or more of Ca²⁺, such as 1400 mg/L or more; 20,000 mg/L or more of Mg²⁺; and/or 65,000 mg/L or more of SO₄²⁻. The draw brine may comprise about 300 to about 2,000 mg/L of Ca²⁺; about 1000 to about 60,000 mg/L of Mg²⁺; and/or about 500 to about 65,000 mg/L or more of SO₄²⁻.

The draw brine may comprise a brine derived from an underground reservoir, such as a Salar brine; a synthetic brine; a waste-stream brine; a brine derived from an evaporation pond, such as a downstream evaporation pond; or a combination thereof.

Salar brines, such as from salars in South America, may comprise: a lithium concentration of 100 ppm or more, such as a concentration from 150 to 400 ppm or from 300 to 700 ppm; a sulfate concentration of 5,000 ppm or more; and/or, a combined magnesium and calcium concentration from 1,000 ppm or more. Waste-stream brines, such as those derived from in potash plant, may comprise a lithium concentration of up to and including 7000 ppm; and/or a sulfate concentration up to and including 65,000 ppm. Brines derived from an evaporation pond, such as a downstream evaporation pond, comprise lithium that has been enriched via series of evaporation ponds. In downstream ponds, the lithium concentration increases as it goes downstream, such that the final pond could comprises much as 6% lithium (˜70,000 ppm).

In one or more example, the draw brine may be any high TDS brine, such as a brine from concentrated Salar ponds, synthetic brines, or waste streams.

### Forward Osmosis Modules and Processes

In one or more example, one or more methods described herein involve forward osmosis (FO) using a first FO module. Operating the first FO module may include any one or combination of the following features.

The first FO module may be operated at a pressure between about 15 psi and about 30 psi. The first FO module may be operated at a pressure between about 15 psi and about 30 psi, when the FO membrane has an area of about 13.8 m².

The FO module may have an input flow rate and/or an output flow rate that corresponds to FO membrane area and/or input/output brines composition. The FO module may have an average flux across the FO membrane that is between about 5 LHM to about 25 LHM, or about 10 LHM to about 25 LHM, or about 15 to about 25 LHM, or about 20 LMH to about 25 LHM. The FO module may have an average flux across the FO membrane that is about 10 LMH to 20 LMH based on feed brine composition. The FO module may have an average flux across the FO membrane that is about 10 LMH-20 LMH, at a pressure between about 15 to about 30 psi.

The first FO module may be operated using a membrane configured to reject about 99% or more of salts. The first FO module may be operated using a hollow fiber membrane, where in the hollow fiber membrane may reject ≥99% of salts. The FO module may be operated using a membrane configured to reject about 99% or more of salts at a pressure between about 15 psi and about 30 psi. The FO module may be operated using a hollow fiber membrane at a pressure between about 15 psi and about 30 psi. The FO module may be operated at a recovery up to, or greater than 75%, where up to, or greater than 75% of water permeates across the membrane, from the feed side to the draw side, removing water from the feed brine to concentrate the feed brine; for example, by 2-5 or 4-5 times.

The first FO module may be operated using a hollow fiber semipermeable membrane comprising an active layer of polyamide thin film composite with integrated protein. The first FO module may be operated using a membrane as described in US Publication No. 20150144553, which is incorporated herein by reference.

In one or more example, one or more methods described herein involve forward osmosis (FO) using a second FO module and/or subsequent FO modules. Operating the second FO module and/or subsequent FO modules may include any one or combination of the following features.

The second FO module and/or subsequent FO modules may be operated at a pressure between about 15 psi to about 30 psi. The second FO module and/or subsequent FO modules may have an input flow rate and/or an output flow rate that corresponds to membrane area and/or input/output brines composition. The second FO module and/or subsequent FO modules may have an input flow rate and/or an output flow rate that is based on the process recovery of the first FO module. The second FO module may have an average flux across the FO membrane that is between about 5 LHM to about 25 LHM, or about 10 LHM to about 25 LHM, or about 10 to about 20 LHM, or about 10 LMH to about 15 LHM. The second FO module and/or subsequent FO modules may have an average flux across the FO membrane that is between about 10 to about 15 LMH. The second FO module and/or subsequent FO modules may have an average flux across the FO membrane that is between about 10 to about 15 LMH, at a pressure between about 15 to about 30 psi.

The second FO module and/or subsequent FO modules may be operated using a membrane configured to reject about 99% or more of salts. The second FO module and/or subsequent FO modules may be operated using a hollow fiber membrane, where in the hollow fiber membrane may reject 299% of salts. The second FO module and/or subsequent FO modules may be operated using a membrane configured to reject about 99% or more of salts at a pressure between about 15 psi and about 30 psi. The FO module may be operated using a hollow fiber membrane at a pressure between about 15 psi and about 30 psi. The FO module may be operated at a recovery up to, or greater than 50%, where up to, or greater than 50% of water permeates across the membrane, from the feed side to the draw side, removing water from the feed brine concentrate, the first FO concentrate, or subsequent FOX concentrates, to concentrate them.

The second FO module and/or subsequent FO modules may be operated using a hollow fiber semipermeable membrane comprising an active layer of polyamide thin film composite with integrated protein. The second FO module and/or subsequent FO modules may be operated using a membrane as described in US Publication No. 20150144553, which is incorporated herein by reference.

### Nano-Filtration Modules and Processes

In one or more examples, one or more methods described herein involve nano-filtration (NF) using an initial NF module. Operating the initial NF module may include any one or combination of the following features.

The initial NF module may be operated at a pressure between about 80 psi to about 1600 psi, or about 130 psi to about 1600 psi or about 80 psi to about 1500 psi, or about 130 psi to about 1500 psi. The initial NF module may be operated at a pressure of about 130 psi. The initial NF module may have an input flow rate and/or an output flow rate that corresponds to membrane area and/or input/output brines composition. The initial NF module may have an average flux across the NF membrane that is between about 5 LHM to about 25 LHM, or about 10 LHM to about 25 LHM, or about 15 to about 25 LHM, or about 20 LMH to about 25 LHM. The initial NF module may have an average flux across the NF membrane that is about 10 LMH to 21 LMH based on feed composition to initial NF module. The initial NF module may have an average flux across the NF membrane that is about 10 LMH to 21 LMH, at a pressure between about 130 psi to 1600 psi.

The initial NF module may be operated at high recovery. The initial NF module may be operated at high recovery at a pressure of about 130 psi to 1600 psi. The initial NF module may be operated at high recovery at a pressure between about 80 psi and about 1500 or 1600 psi. The initial NF module may be operated at high recovery that rejects between about 80% to about 99% of Ca²⁺, Mg²⁺, and/or SO₄²⁻.

The initial NF module may be operated at a divalent % rejection that corresponds to the input brine composition, such as the divalent ion concentration of the input brine; and/or corresponds to the pressure applied across the NF membrane. The initial NF module may be operated using an NF membrane that rejects about 80% to about 85% of Ca²⁺, about 90% to about 95% of Mg²⁺, and/or about 97% to about 99% of SO₄²⁻.

In one or more examples, one or more methods described herein involve nano-filtration (NF) using a first NF module. Operating the first NF module may include any one or combination of the following features.

The first NF module may be operated at a pressure of up to 800 psi, or up to 1500 or 1600 psi; or at a pressure between about 80 psi to about 1500 or 1600 psi. The first NF module may have an input flow rate and/or an output flow rate that corresponds to membrane area and/or input/output brines composition. The first NF module may have an input flow rate and/or an output flow rate that corresponds to membrane area, diluted draw brine concentration, and/or permeate output with applied pressure. In one or more examples, the % recovery, % divalent ion rejection, and/or pressure range of the first NF module membrane may depend on input brine composition (dilute draw brine), such as ion concentrations.

The first NF module may be operated at a recovery of about 70% to about 75% (based on permeate). The first NF module may be operated at a recovery of about 70% to about 75% (based on permeate) at a pressure of about 1300 to about 1400 or 1600 Psi. The first NF module may be operated at a pressure between about 800 psi and about 1300 or 1600 psi. The first NF module may be operated at a pressure between about 80 psi and about 1500 or 1600 psi. The first NF module may be operated using an NF membrane that rejects between about 50% to about 99% of Ca²⁺, Mg²⁺, and/or SO₄²⁻. The first NF module may be operated at a divalent % rejection that corresponds to the input brine composition, such as the divalent ion concentration of the input brine; and/or corresponds to the pressure applied across the NF membrane. The first NF module may be operated using an NF membrane that rejects about 80% to about 85% of Ca²⁺, about 90% to about 95% of Mg²⁺, and/or about 97% to about 99% of SO₄²⁻. The first NF module may be operated using an NF membrane that rejects about 50% to about 60% of Ca²⁺, about 80% to about 85% of Mg²⁺, and/or about 97% to about 99% of SO₄²⁻.

In one or more examples, one or more methods described herein involve nano-filtration (NF) using a second NF module and/or subsequent NF modules. Operating the second NF module and/or subsequent NF modules may depend on the input brine composition (NF permeates), and/or the pressure applied across the NF membrane.

In one or more examples, one or more methods described herein involve nano-filtration (NF) using an initial NF module, a first NF module, a second NF module and/or subsequent NF modules. The NF membrane of any one of said NF modules may comprise a thin film composite (TFC) spiral wound NF membrane. The TFC spiral-wound NF membrane may comprise one or more of the following specifications: a membrane polymer comprising standard NF polyamide; a molecular weight cut off of about 150 to about 300 Dalton; % rejection across may be dependent on input brine composition (dilute draw brine, NF permeates) and/or applied pressure across NF membranes; a temperature tolerance of about 15° C. to about 50° C.; a pressure tolerance up about to 1500 or 1600 Psi; a solvent resistance to acidic and/or alkali solvent (such as a pH between 3 to 11); or a combination thereof. The NF membranes may be used in a pressure vessel arrangement, where a single pressure vessel may contain five to six NF membrane elements. These elements may be arranged in a number of stacks based on flow capacity.

### Exemplary Methods and Systems Thereof

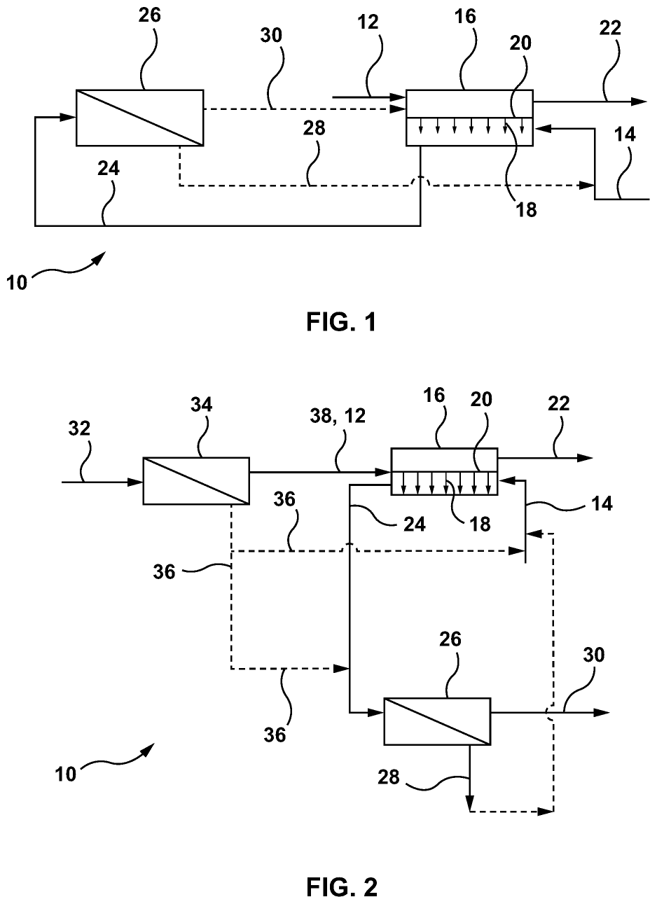

FIG. 1 depicts a flow diagram of an embodiment of a system 10 and method for processing brine comprising lithium, as described herein. The method comprises providing a Feed Brine 12 and a Draw Brine 14 to a first forward osmosis (FO1) module 16, where the Draw Brine 14 comprises lithium, or the Feed Brine 12 and the Draw Brine 14 comprises lithium. The Feed Brine 12 has a lower osmotic pressure than the Draw Brine 14; and thus, once provided to the FO1 module 16, water 18 is drawn across a semi-permeable forward osmosis (FO) membrane 20 from the Feed Brine 12 to the Draw Brine 14 due to a difference in osmotic pressures. As water 18 is drawn from the Feed Brine 12, a Feed Brine Concentrate 22 is formed, which has a higher osmotic pressure than the Feed Brine 12. When the Feed Brine 12 comprises lithium, concentrating the Feed Brine 12 via the FO1 module 16 reduces water content and increases lithium concentrations, thereby facilitating lithium recovery and increasing lithium yields.

As water 18 diffuses across the membrane 20 into the Draw Brine 14, a Dilute Draw Brine 24 is formed that has a lower osmotic pressure than the Draw Brine 14. When the Draw Brine 14 comprises lithium, diluting the Draw Brine 14 via the FO1 module 16 decreases the osmotic pressure of the Draw Brine 14, allowing the Draw Brine 14 to be processed, as desired, by other membrane-based methods that otherwise would not have been able to tolerate its osmotic pressure. This may facilitate recovery of lithium that would have otherwise been difficult to recover due to the high osmotic pressure of the brine within which it was contained.

Both the Feed Brine Concentrate 22 and Dilute Draw Brine 24 are then respectively discharged from the FO1 Module 16. The Dilute Draw Brine 24 is provided to a first nanofiltration (NF1) module 26 to filter out at least a percentage of any divalent ions that may be present in the Dilute Draw Brine 24. Divalent ions that may be present in the Dilute Draw Brine 24 include of Ca²⁺, Mg²⁺, and/or SO₄²⁻. When the Dilute Draw Brine 24 comprises such divalent ions, removing those at least partially purifies the Dilute Draw Brine 24, and further reduces its osmotic pressure, facilitating its capacity to be processed by other membrane-based methods. If the Feed Brine 12 comprises lithium, the Feed Brine Concentrate 22 may be subject to further concentration and/or purification steps, such as multi-pass forward osmosis, ion exchange (IX), evaporation, crystallization, or a combination thereof, to facilitate lithium recovery.

From the NF1 module 26, a NF1 Retentate 28 and NF1 Permeate 30 are formed and discharged. The NF1 Retentate 28 comprises at least a portion of the filtered out divalent ions from the Dilute Draw Brine 24, and the NF1 Permeate 30 comprises as least a portion of the lithium comprised by the Dilute Draw Brine 24. At least a portion of the NF1 Retentate 28 may be recycled back to the FO1 module 16, and may be mixed with the Draw Brine 14 being provided to the FO1 module 16 (dashed line), due to its higher divalent ion concentration and subsequently higher osmotic pressure. Recycling of the NF1 Retentate 28 may continue until ion saturation is reached. The NF1 Permeate 30 may be subject to further concentration and/or purification steps, such as multi-pass nano-filtration, ion exchange (IX), evaporation, crystallization, or a combination thereof, to facilitate lithium recovery. Alternatively, at least a portion of the NF1 Permeate 30 may be mixed with the Feed Brine 12 being provided to the FO1 module 16 for further concentration; or the NF1 Permeate 30 may be used as the Feed Brine 12.

As needed, the brines, concentrates, permeates, or retentates may be bled off as ion-saturation is met.

The method as depicted in FIG. 1 may: provide recovery of Li from untreatable brines; provide overall Li yield enhancement; avoid requirement of adding make-up water or make-up aqueous solutions to dilute input brines (feed brines, permeates, etc.); replace high pressure reverse osmosis (RO)-based processes; offer lower operating cost due to lower energy requirements for FO processes; offer reduced transportation costs due to lower volume of final concentrates/permeates which may have an enriched lithium concentration; or a combination thereof.

FIG. 2 depicts a flow diagram of another embodiment of a method for processing brine comprising lithium, as described herein. Many of the features of depicted in FIG. 2 are similar to those shown and described above with reference to FIG. 1, and so are not described again in detail to avoid obscuring the description. Where similar features are described with reference to FIG. 2, similar references are used. In general, elements with the a reference numeral in one of the Figures are similar to elements with the same reference numeral in other Figures, unless described differently herein.

The system 10 and method as depicted in FIG. 2 comprises providing a First Brine 32 to an initial NF module (NFI) 34 that is upstream of a first forward osmosis (FO1) module 16. The First Brine 32 may comprise lithium. The First Brine 32 is provided to the NFI module 34 to filter out at least a percentage of any divalent ions that may be present in the First Brine 32, such as Ca²⁺, Mg²⁺, and/or SO₄²⁻, to purify the First Brine 32 and/or reduce its osmotic pressure, facilitating its capacity to be processed by other membrane-based methods, such as forward osmosis.

From the NFI module 34, a NFI Retentate 36 and Feed Brine 12 (which is also NFI Permeate 38) are formed and discharged. The Feed Brine 12 and a Draw Brine 14 comprising lithium are provided to a first forward osmosis (FO1) module 16, simultaneously concentrating the Feed Brine 12, forming a Feed Brine Concentrate 22; and diluting the Draw Brine 14, forming a Dilute Draw Brine 24. If the First Brine 32 comprises lithium, the Feed Brine Concentrate 22 may be subject to further concentration and/or purification steps, such as ion exchange (IX), evaporation, crystallization, or a combination thereof, to facilitate lithium recovery. Once diluted, with a corresponding decrease in osmotic pressure, the Dilute Draw Brine 24 can be provided at least in part to (i) the NFI module 34 (not shown), or (ii) a first nanofiltration (NF1) module 26 (shown) to filter out at least a percentage of any divalent ions that may be present in the Dilute Draw Brine 24. When at least a part of the Dilute Draw Brine 24 is provided to the NFI module 34, that amount may be selected to minimize any potential impact on the downstream FO1 module 16 that may arise due to differences in osmotic pressures between the First Brine 32 and the Dilute Draw Brine 24. The NF1 module 26 may have a lower % recovery, and may operate at a higher pressure, than the NFI module 34 due to a higher concentration of ions or a higher TDS of Dilute Draw Brine 24. This may facilitate at least partially purifying the Dilute Draw Brine 24 and reducing its osmotic pressure, aiding in its capacity to be processed by other membrane-based methods, and/or facilitating lithium recovery and increasing lithium yields.

The NFI Retentate 36 comprises at least a portion of the filtered out divalent ions from the First Brine 32; and as such, at least a portion of the NFI Retentate 36 may be provided to the FO1 module 16 for further processing, optionally as a draw brine or mixed with the Draw Brine 14 being provided to the FO1 module 16 (upper dashed line), due to its higher divalent ion concentration and subsequently higher osmotic pressure. At least a portion of the NFI Retentate 36 may be provided to the NF1 module 26 for further processing, and may be optionally mixed with the Dilute Draw Brine 24 (lower dashed line).

From the NF1 module 26, a NF1 Retentate 28 and NF1 Permeate 30 are formed and discharged. The NF1 Permeate 30 may be subject to further concentration and/or purification steps, such as ion exchange (IX), evaporation, crystallization, or a combination thereof, to facilitate recovery of at least some of the lithium comprised in the Draw Brine 14. The NF1 Retentate 28 comprises at least a portion of the filtered out divalent ions from the Dilute Draw Brine 24; and as such, at least a portion of the NF1 Retentate 28 may be provided to the FO1 module 16 for further processing, and may be mixed with the Draw Brine 14 being provided to the FO1 module 16 (dashed line), due to its higher divalent ion concentration and subsequently higher osmotic pressure.

As needed, the brines, concentrates, permeates, or retentates may be bled off as ion-saturation is met.

The method as depicted in FIG. 2 may: provide recovery of Li from untreatable brines; provide overall Li yield enhancement; provide overall increased Li yield due to a reduction in divalent impurities in concentrate/permeate streams; avoid requirement of adding make-up water or make-up aqueous solutions to dilute input brines (first brines, feed brines, permeates, etc.); replace high pressure reverse osmosis (RO)-based processes; offer lower operating cost due to lower energy requirements for FO processes; offer reduced transportation costs due to lower volume of final concentrates/permeates which may have an enriched lithium concentration; or a combination thereof.

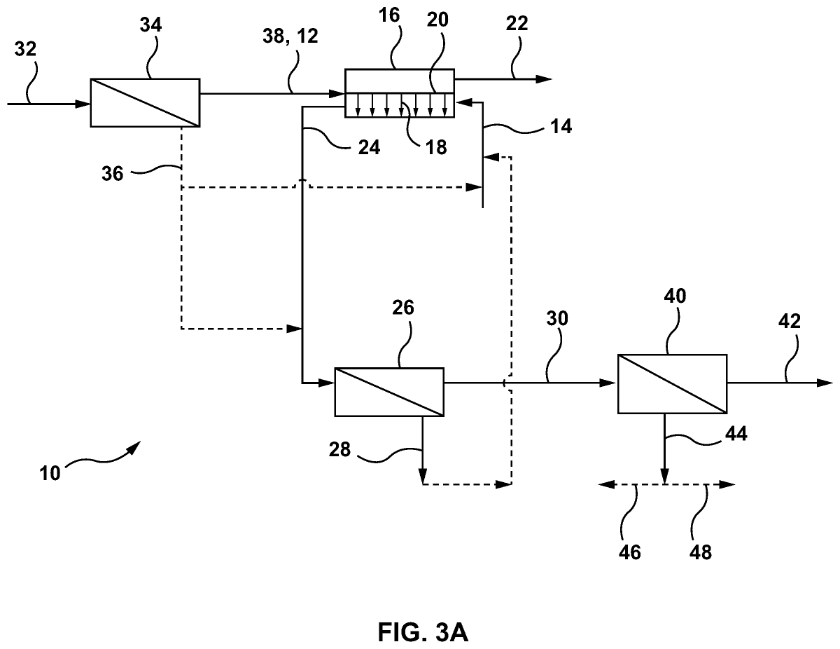

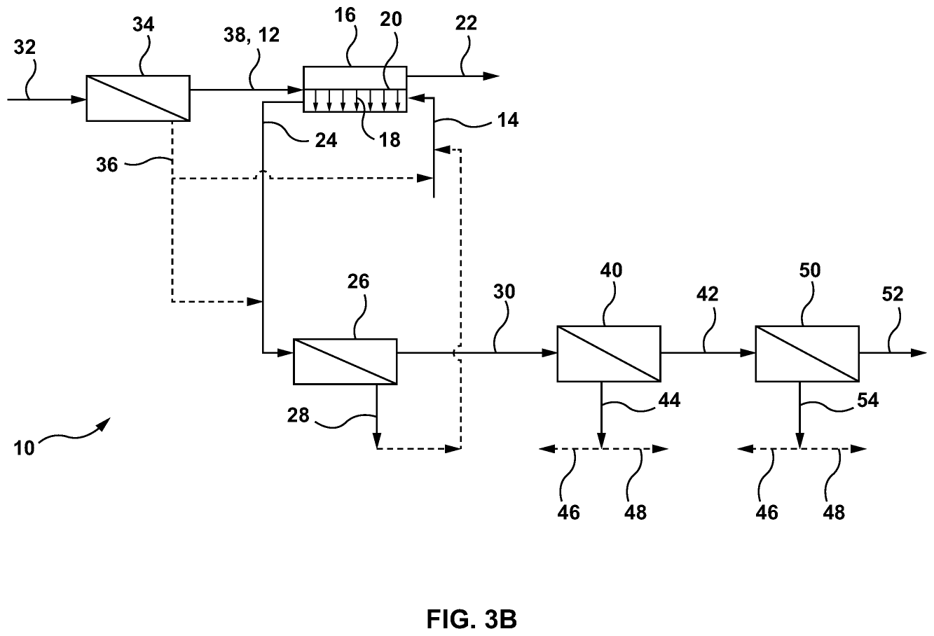

FIGS. 3A and 3B depict flow diagrams of other embodiments of a system 10 and method for processing brine comprising lithium, as described herein. Many of the features depicted in FIGS. 3A and 3B are similar to those shown and described above with reference to FIG. 1 and FIG. 2, and so are not described again in detail to avoid obscuring the description. Where similar features are described with reference to FIGS. 3A and 3B, similar references are used.

The method as depicted in FIG. 3A comprises providing a First Brine 32, which may comprise lithium, to an initial nanofiltration (NFI) module 34 and forming a NFI Retentate 36 and Feed Brine 12 (NFI Permeate 38). The Feed Brine 12 and a Draw Brine 14 comprising lithium are provided to a first forward osmosis (FO1) module 16 to form a Feed Brine Concentrate 22 and a Dilute Draw Brine 24. If the First Brine 32 comprises lithium, the Feed Brine Concentrate 22 may be subject to further concentration and/or purification steps, such as ion exchange (IX), evaporation, crystallization, or a combination thereof, to facilitate lithium recovery. The Dilute Draw Brine 24 can be provided at least in part to (i) the NFI module 34 (not shown), or (ii) a first nanofiltration (NF1) module 26 (shown) to filter out at least a percentage of any divalent ions that may be present in the Dilute Draw Brine 24. When at least a part of the Dilute Draw Brine 24 is provided to the NFI module 34, that amount may be selected to minimize any potential impact on the downstream FO1 module 16 that may arise due to differences in osmotic pressures between the First Brine 32 and the Dilute Draw Brine 24. The NF1 module 26 may have a lower % divalent ion rejection and higher operating pressure than the NFI module 34.

At least a portion of the NFI Retentate 36, comprising at least a portion of the filtered out divalent ions from the First Brine 32, may be provided to the FO1 module 26 for further processing, optionally as a draw brine; mixed with the Draw Brine 14 (upper dashed line); and/or at least a portion of the NFI Retentate 36 may be provided to the NF1 module 26 for further processing, and may be optionally mixed with the Dilute Draw Brine 24 (lower dashed line).

From the NF1 module 26, a NF1 Retentate 28 and NF1 Permeate 30 are formed and discharged. The NF1 Permeate 30, comprising at least a portion of the lithium comprised in the Draw Brine 14, is provided to a second nanofiltration (NF2) module 40 that is downstream of the NF1 module 26 to filter out at least a percentage of any divalent ions remaining in the Dilute Draw Brine 24 following processing through the NF1 module 26. The NF1 module 26 may remove a majority of the divalent ions impurities in the Dilute Draw Brine 24, and impurities remaining in the NF1 permeate 30 may be removed by the NF2 module 40 to produce final permeate (NF2 Permeate 42) with a lower concentration of divalent impurities. The NF2 module 40 may have a higher % ion rejection, and may operate at equal or lower pressure than the NF1 module 26, due to a lower NF1 Permeate 30 osmotic pressure as feed to the NF2 module 40. This may facilitate at least partially purifying the NF1 Permeate 30 further, and reducing further its osmotic pressure, aiding in its capacity to be processed by other membrane-based methods, and/or facilitating lithium recovery and increasing lithium yields. The NF1 Retentate 28 comprises at least a portion of the filtered out divalent ions from the Dilute Draw Brine 24; and as such, at least a portion of the NF1 Retentate 28 may be provided to the FO1 module 16 for further processing, and may be mixed with the Draw Brine 14 being provided to the FO1 module 16 (dashed line). Alternatively, The NF1 retentate 28, or at least portions thereof, may be recycled upstream and/or downstream of the NF1 module 26 (e.g., to FO modules as a draw brine, or NF modules; not shown), or be subject to evaporation ponds, thermal ZLD processes, physiochemical treatments etc., for further lithium recovery.

From the NF2 module 40, a NF2 Retentate 44 and NF2 Permeate 42 are formed and discharged. The NF2 Permeate 42 may be subject to further concentration and/or purification steps, such as ion exchange (IX), evaporation, crystallization, or a combination thereof, to facilitate recovery of at least some of the lithium comprised in the Draw Brine 14. The NF2 Retentate 44, or at least portions thereof, may be recycled upstream 46 and/or downstream 48 of the NF2 module 40 (for example, to FO modules as part of a draw brine, or NF modules; see dashed arrows), or subject to evaporation ponds, thermal ZLD processes, physiochemical treatments etc., for further lithium recovery).

As depicted in FIG. 3B, the NF2 Permeate may be provided to one or more subsequent NF (NFX) modules 50 to continue to filter out at least a percentage of any divalent ions that may be present in the NF2 Permeate 42. The NFX module(s) 50 may have a higher % divalent ion rejection, and may operate at equal or lower pressure than upstream NF modules (NF1 module 26, NF2 module 40, etc.) due to the NF2 Permeate 42 having a lower osmotic pressure. This may facilitate continuing at least partially purifying the NF2 Permeate 42 and reducing its osmotic pressure, aiding in its capacity to be processed by other membrane-based methods, and/or facilitating lithium recovery and increasing lithium yields. From the NFX module 50, a NFX Retentate 54 and NFX Permeate 52 are formed and discharged. The NFX Permeate 52 may be subject to further concentration and/or purification steps, such as ion exchange (IX), evaporation, crystallization, or a combination thereof, to facilitate continued recovery of at least some of the lithium comprised in the Draw Brine 14. The NFX Retentate 54, or at least portions thereof, may be recycled upstream 46 and/or downstream 48 of the NFX module 50 (for example, to the FO modules as part of a draw brine, or NF modules; see dashed arrows), or be subject to evaporation ponds, thermal ZLD processes, physiochemical treatments etc., for further lithium recovery.

As needed, the brines, concentrates, permeates, or retentates may be bled off as ion-saturation is met.

The method as depicted in FIG. 3a or 3b provides multi-pass nanofiltration (NF) coupled with a single pass forward osmosis (FO), which may purify a brine comprising lithium by removing divalent ions (up to a minimum level using the NF) and enriching the lithium concentration (using FO). Further, the method as depicted in FIG. 3a or 3b may: provide recovery of Li from untreatable brines; provide overall Li yield enhancement; provide overall increased Li yield due to a reduction in divalent impurities in concentrate/permeate streams; avoid requirement of adding make-up water or make-up aqueous solutions to dilute input brines (first brines, feed brines, permeates, etc.); replace high pressure reverse osmosis (RO)-based processes; offer lower operating cost due to lower energy requirements for FO processes; offer reduced transportation costs due to lower volume of final concentrates/permeates which may have an enriched lithium concentration; or a combination thereof.

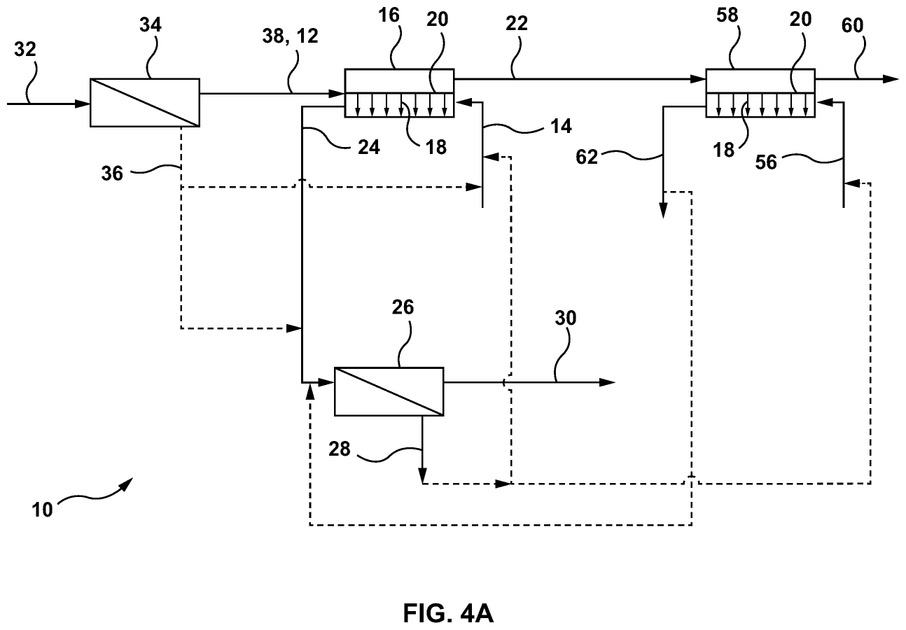

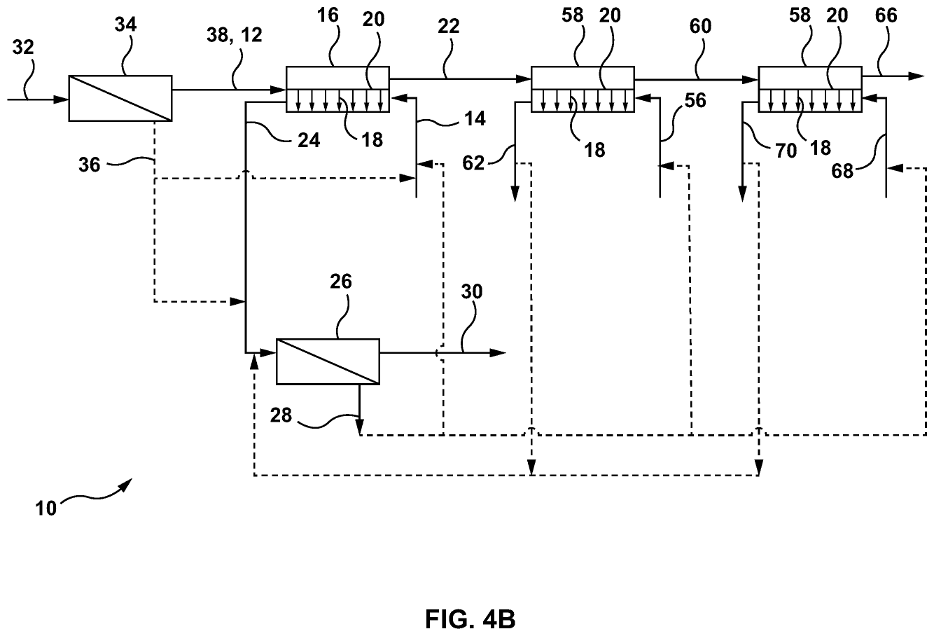

FIGS. 4A and 4B depict flow diagrams of other embodiments of a method for processing brine comprising lithium, as described herein. Many of the features depicted in FIGS. 4A and 4B are similar to those shown and described above with reference to FIG. 1 and FIG. 2, and so are not described again in detail to avoid obscuring the description. Where similar features are described with reference to FIGS. 4A and 4B, similar references are used.

The method as depicted in FIG. 4A comprises providing a First Brine 32 to an initial NF module (NFI module 34) that is upstream of a first FO module (FO1 module 16). The First Brine 32 comprises lithium. The First Brine 32 is provided to the NFI module 34 to filter out at least a percentage of any divalent ions that may be present in the First Brine 32, such as Ca²⁺, Mg²⁺, and/or SO₄²⁻, to purify the First Brine 32 and/or reduce its osmotic pressure, facilitating its capacity to be processed by other membrane-based methods, such as forward osmosis.

From the NFI module 34, a NFI Retentate 36 and Feed Brine 12 (NFI Permeate 38) are formed and discharged. The Feed Brine 12 and a Draw Brine 14 comprising lithium are provided to a first FO module (FO1 module 16), forming a Feed Brine Concentrate 22 and a Dilute Draw Brine 24.

The Dilute Draw Brine 24 can be provided at least in part to (i) the NFI module (not shown), or (ii) a first NF module (NF1 module 26) (shown) to filter out at least a percentage of any divalent ions that may be present in the Dilute Draw Brine 24, forming an NF1 Permeate 20. When at least a part of the Dilute Draw Brine 24 is provided to the NFI module 26, that amount may be selected to minimize any potential impact on the downstream FO1 module 16 that may arise due to differences in osmotic pressures between the First Brine 32 and the Dilute Draw Brine 24. The NF1 module 26 may have a lower % ion rejection, and may operate at a higher pressure, than the NFI module 34. At least a portion of the NFI Retentate 36 may be provided to the FO1 module 16 for further processing, optionally as a draw brine; mixed with the Draw Brine 14 (upper dashed line); and/or at least a portion of the NFI Retentate 36 may be provided to the NF1 module 26 for further processing, and may be optionally mixed with the Dilute Draw Brine 24 (lower dashed line).

The Feed Brine Concentrate 22 and a First Draw Solution 56 is provided to a second FO module (FO2 module 58) to simultaneously concentrate the Feed Brine Concentrate 22 further, forming a First FO Concentrate 60; and to dilute the First Draw Solution 56, forming a First FO Diluted Draw 62. Providing the Feed Brine Concentrate 22 to the FO2 module 58 further reduces its water content and can increase lithium concentration, which can facilitate lithium recovery and increase lithium yields. The FO2 module 58 may have similar % ion rejection to the FO1 module 16, but may have a recovery that is less than FO1 module 16. The First FO Concentrate 60 may then be subject to further concentration and/or purification steps, such as ion exchange (IX), evaporation, crystallization, or a combination thereof, to facilitate recovery of at least some of the lithium comprised in the First Brine 32. The First FO Diluted Draw 62, or at least portions thereof, may be recycled upstream and/or downstream of the FO2 module 58 (for example, to the NF1 module (dashed line)). The First FO Diluted Draw 62, or at least portions thereof, may not be recycled to an NF module if the divalent ions concentration is about Ca²⁺≥2000 ppm, Mg²⁺≥30,000 ppm or ≥20,000 ppm, SO₄²⁻≥30,000 ppm. First FO Diluted Draw 62 comprising such concentrations of divalent ions may need dilution (e.g., with water, aqueous solutions) or very high pressures for NF operations; or may need to be subject to evaporation ponds, thermal ZLD processes, physiochemical treatments, etc.

The NF1 Permeate 20 discharged from the NF1 module may 26 be subject to further concentration and/or purification steps, such as ion exchange (IX), evaporation, crystallization, or a combination thereof, to facilitate recovery of at least some of the lithium comprised in the Draw Brine 14. The NF1 Retentate 28 discharged from the NF1 module 26 comprises at least a portion of the filtered out divalent ions from the Dilute Draw Brine 24; and as such, at least a portion of the NF1 Retentate 28 may be provided to the FO1 module 16 or the FO2 module 58 for further processing, optionally as a draw brine; may be mixed with the Draw Brine 14 being provided to the FO1 module 16; and/or the First Draw Solution 56 being provided to the FO2 module 58 (dashed line).

As depicted in FIG. 4B, the First FO Concentrate 60 may be provided to one or more subsequent FO modules (FOX module 64) to continue to reduce water content in the First FO Concentrate 60, which can increase lithium concentration and facilitate lithium recovery and increase lithium yields. Such successive concentrations may continue until ion-saturation occurs. The FOX module 64 may have a lower or equivalent % ion rejection than the FO2 module 58. From the FOX module 64, a FOX Diluted Draw 70 and FOX Concentrate 66 is formed and discharged. The FOX Concentrate 66 may be subject to further concentration and/or purification steps, such as ion exchange (IX), evaporation, crystallization, or a combination thereof, to facilitate continued recovery of at least some of the lithium comprised in the First Brine 32. The FOX Diluted Draw 70, or at least portions thereof, may be recycled upstream and/or downstream of the FOX module 64 (for example, to the NF1 module 26). The FOX Diluted Draw 70, or at least portions thereof, may not be recycled to an NF module if the divalent ions concentration is about Ca²⁺≥2000 ppm, Mg²⁺≥30,000 ppm or ≥20,000 ppm, SO₄²⁻≥30,000 ppm. FOX Diluted Draw 70 comprising such concentrations of divalent ions may need dilution (e.g., with water, aqueous solutions) or very high pressures for NF operations; or may need to be subject to evaporation ponds, thermal ZLD processes, physiochemical treatments etc.

As needed, the brines, concentrates, permeates, or retentates may be bled off as ion-saturation is met.

The method as depicted in FIG. 4a or 4b provides multi-pass forward osmosis (FO) with a single pass nanofiltration (NF), which may concentrate lithium in the final concentrates to improve lithium yield and purity (e.g., lower concentration of divalent ions, etc.). Further, the method as depicted in FIG. 4a or 4b may: provide recovery of Li from untreatable brines; provide overall Li yield enhancement; provide overall increased Li yield due to a reduction in divalent impurities in concentrate/permeate streams; avoid requirement of adding make-up water or make-up aqueous solutions to dilute input brines (first brines, feed brines, permeates, etc.); replace high pressure reverse osmosis (RO)-based processes; offer lower operating cost due to lower energy requirements for FO processes; offer reduced transportation costs due to lower volume of final concentrates/permeates which may have an enriched lithium concentration; or a combination thereof.

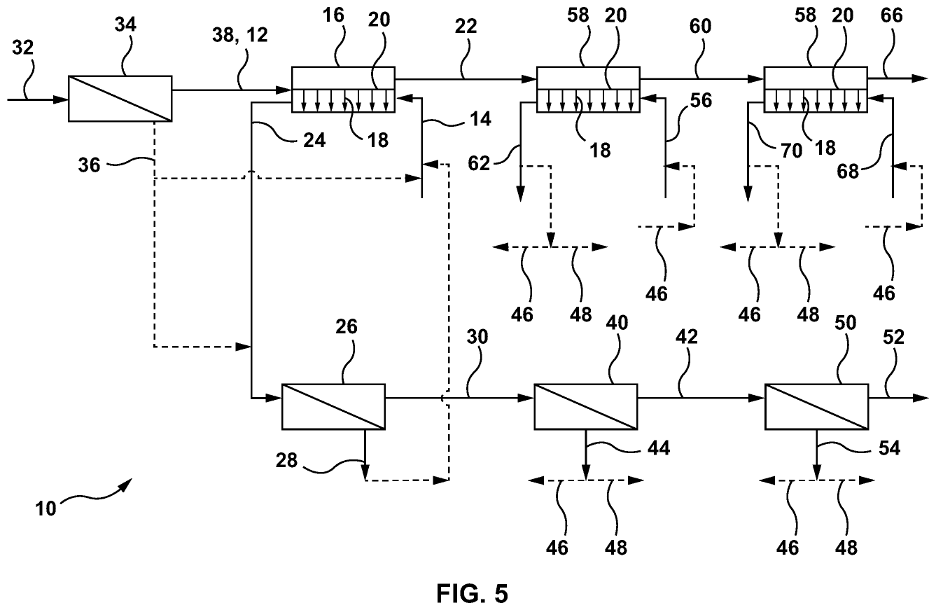

FIG. 5 depict a flow diagram of another embodiment of a system 10 and method for processing brine comprising lithium, as described herein. Many of the features depicted in FIG. 5 are similar to those shown and described above with reference to FIGS. 3B and 4B, and so are not described again in detail to avoid obscuring the description. Where similar features are described with reference to FIGS. 3B and 4B, similar references are used.

The method as depicted in FIG. 5 comprises a combination of the methods depicted in FIGS. 3B and 4B.

A First Brine 32 comprising lithium is provided to an initial NF module (NFI module), forming a Feed Brine 12. The Feed Brine 12 is provided to a first FO module (FO1 module 16), forming a Feed Brine Concentrate 22 that is provided to a second FO module (FO2 module 58), forming a First FO Concentrate 60 that is provided to one or more subsequent FO modules (FOX module 64) to form a FOX Concentrate 66. The NFI module 34 filters out at least a percentage of any divalent ions that may be present in the First Brine 32, such as Ca²⁺, Mg²⁺, and/or SO₄²⁻, to purify the First Brine 32 and/or reduce its osmotic pressure, facilitating its capacity to be processed by other membrane-based methods (such as the subsequent FO processes depicted). The FO1 module 16, FO2 module 58 and FOX modules 64 reject >99% salt and permeate water from the feed to the draw side across the FO module. Going downstream from FO1 module 16 to FOX module 64 can result in a sequentially lower % recovery in each forward osmosis module, while sequentially reducing water content in the Feed Brine and subsequent FO Concentrates, which can increase lithium concentration and facilitate recovery of at least some of the lithium present in the First Brine.

A Draw Brine 14 comprising lithium is provided to the FO1 module 16, forming a Dilute Draw Brine 24. The Dilute Draw Brine 24 is provided to a first NF module (NF1 module 26), forming a first NF Permeate (NF1 Permeate 20) that is provided to a second NF module (NF2 module 40), forming a second NF Permeate (NF2 Permeate 42) that is provided to one or more subsequent NF modules (NFX module 50) to form a NFX Permeate 52. The NF1 module 26 may have a lower % recovery and higher operating pressure than the NFI module 34, due to a higher diluted draw brine osmotic pressure as feed to NF1 module 26. The NF2 module 40 and NFX modules 50 may have an overall higher % ion rejection, and may operate at equal or a lower pressure, than the NF1 module 26. The NF modules 26, 40, 50 sequentially filter out at least a percentage of any divalent ions that may be present, such as Ca²⁺, Mg²⁺, and/or SO₄²⁻, to purify the Dilute Draw Brine 24 and subsequent NF Permeates 20, 42, and/or reduce their osmotic pressures, facilitating their capacity to be processed by other membrane-based methods (such as the subsequent NF processes depicted), which can increase lithium concentration and facilitate recovery of at least some of the lithium present in the Draw Brine 14.

As needed, the brines, concentrates, permeates, or retentates may be bled off as ion-saturation is met.

The method as depicted in FIG. 5 may: provide recovery of Li from untreatable brines; provide overall Li yield enhancement; provide overall increased Li yield due to a reduction in divalent impurities in concentrate/permeate streams; avoid requirement of adding make-up water or make-up aqueous solutions to dilute input brines (first brines, feed brines, permeates, etc.); replace high pressure reverse osmosis (RO)-based processes; offer lower operating cost due to lower energy requirements for FO processes; offer reduced transportation costs due to lower volume of final concentrates/permeates which may have an enriched lithium concentration; or a combination thereof.

One or more of the methods depicted in FIG. 1 to 5, or one or more of the methods as described herein, may offer increased yield of lithium recovery relative to at least some of the incumbent processes, such as solar evaporation, precipitation, etc. Such incumbent processes are generally time consuming, and can result in a lower overall lithium yield (for example, about 40-50%) due to (i) loss of lithium via co-precipitation, such as with divalent ions (Ca²⁺, Mg²⁺, SO₄²⁻), (ii) due to higher TDS lithium brines that are generally difficult to process by membrane-based processes due to their high concentration of dissolved solids, and/or higher osmotic pressures; or (iii) due to lithium brines that have a higher divalent ion concentration, making them generally difficult to process by membrane-based processes due to their higher osmotic pressures.

Further, one or more of the methods depicted in FIG. 1 to 5, or one or more of the methods as described herein, may offer increased ease of lithium recovery, relative to at least some of the other incumbent processes. Some locations of lithium sources may exist under drought climate conditions during at least some times of the year, and/or there may be minimal water inherently available on-site for lithium processing (for example, the Salars of Latin America). DLE generates an eluent that can be very dilute, and may need further processing like reverse osmosis (RO) and/or thermal evaporation to concentrate it. However, RO can suffer from TDS limitations (<1 lakh ppm), and higher power consumption with increasing TDS; and thermal evaporation can take months or years.

In contrast, one or more of the methods depicted in FIG. 1 to 5, or one or more of the methods as described herein may (i) allow treatment of higher TDS brines comprising lithium, which would not otherwise be treatable by membranes-based processes due to their high solids concentrations and/or high osmotic pressures (for example, from divalent ions), by diluting them via FO processes and reducing their inherent osmotic pressures, thereby allowing use of membrane-based nano-filtration for further processing; (ii) allow for dilution of higher TDS brines comprising lithium via on-site water generation using FO processes where water is drawn from a feed stream into the higher TDS brine; (iii) allow concentration of brines comprising lithium that comprise higher concentrations of divalent ions, and thus have a higher osmotic pressure, by removing at least a percentage of the divalent ions comprised in the brine via NF processes and then concentrating via FO processes, thereby reducing time for further processing (for example, evaporation), or loss of lithium via co-precipitation; (iv) allow at least partial purification of brines comprising lithium that also comprise divalent ions, by removing at least a percentage of the divalent ions comprised in the brine via NF processes; (v) allow for replacement of Reverse Osmosis (RO) based processes with FO based processes for concentrating lower TDS brines comprising lithium; (vi) allow further processing of NF waste streams (for example, NF Retentates), for recovery of lithium that would otherwise be unrecoverable; and/or (vii) a combination thereof. As a result, one or more of the methods depicted in FIG. 1 to 5, or one or more of the methods as described herein may (i) improve overall lithium recoveries and/or yields; (ii) reduce lithium loss generally experienced when using at least some of the incumbent processes; (iii) allow lithium recovery from the brines which would otherwise be left as a waste product; and/or (iv) use brines already available on-site, such as in the Salars.

One or more of the methods depicted in FIG. 1 to 5, or one or more of the methods as described herein may: provide recovery of Li from untreatable brines; provide overall Li yield enhancement; provide overall increased Li yield due to a reduction in divalent impurities in concentrate/permeate streams; avoid requirement of adding make-up water or make-up aqueous solutions to dilute input brines (first brines, feed brines, permeates, etc.); replace high pressure reverse osmosis (RO)-based processes; offer lower operating cost due to lower energy requirements for FO processes; offer reduced transportation costs due to lower volume of final concentrates/permeates which may have an enriched lithium concentration; or a combination thereof.

### Lithium Recovery Processes

In one or more examples, one or more methods as described herein further comprise recovering lithium. Final recovery of lithium from one or more methods as described may comprise Ion exchange (IX), thermal ZLD (Evaporation, Crystallization, etc), physiochemical treatments, or a combination thereof. In some examples, the lithium recovered is battery grade lithium.

To gain a better understanding of the invention described herein, the following examples are set forth. It should be understood that these examples are for illustrative purposes only. Therefore, they should not limit the scope of this invention in anyway.

### EXAMPLES

### Example 1—Application of Nano-Filtration (NF) and Forward Osmosis (FO) for Increasing Lithium Yield

### SUMMARY

Purification of a relatively low TDS lithium brine by removal of divalent ions was carried out using a nano-filtration module (NFI). Simultaneous concentration of the lower TDS lithium brine (permeate of NFI) and dilution of a relatively higher TDS brine was conducted using a forward osmosis module (FO1). Further purification of the diluted high TDS brine was carried out using another nanofiltration module (NF1). Products for further use included the concentrated low TDS stream from FO1 and the permeate from NF1.

### Results

Described is a method for purification and concentration of lithium from relatively low TDS or salar brines (for example, 10,000-250,000 mg/L TDS or 10,000-30,000 mg/L TDS), such as one derived from Direct Lithium Eluent (DLE) or Salar brine (150,000-250,000 mg/L); and relatively high TDS lithium brines (for example, 4-8 lakh mg/L TDS) by applying nano-filtration (NF) to remove divalent ions and forward osmosis (FO) to produce a final concentrated product with enriched lithium concentration. Simultaneously, FO dilutes the higher TDS brine (4-8 lakh mg/L TDS) to make it more readily treatable via an additional nano-filtration module. A single or multi-pass NF process together with single or multi-pass FO process may be employed.

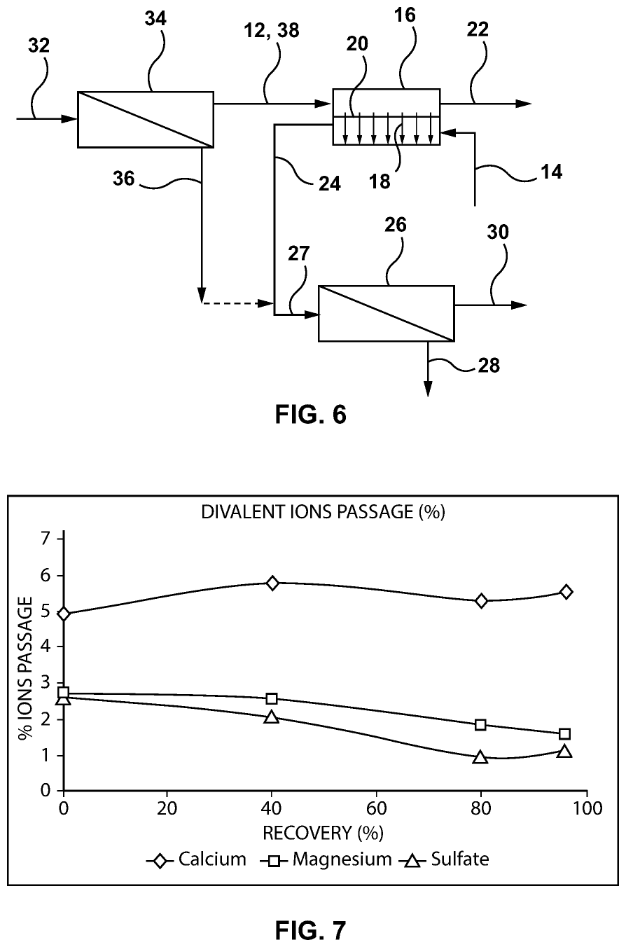

With reference to FIG. 6, a brine comprising lithium (e.g., a lower TDS brine, such as a DLE brine; First Brine 32) was treated via an initial nano-filtration module (NFI module 34) to remove divalent ions, such as Mg²⁺, Ca²⁺, and/or SO₄²⁻ and to form a NFI Permeate 38 (Feed Brine 12) that was used as a feed brine for first forward osmosis module (FO1 module 16). A higher TDS brine stream comprising lithium, which would generally have been un-processable, was used as a Draw Brine 14 for FO1 module 16 due to its higher osmotic pressure. Following being provided to the FO1 module 16, the Draw Brine 14 was diluted due to movement of water 18 from the feed brine across the semi-permeable FO membrane 20 of the FO1 module 16 into the Draw Brine 14, which formed a Dilute Draw Brine 24 that was then treated via a first nano-filtration module (NF1 module 26; NF1 Feed 27) to facilitate the recovery of lithium which may otherwise have not been recoverable. In some examples, at least part of an initial NF retentate (NFI Retentate 36) discharged from the initial NFI module 34 was also provided to the NF1 module 26 as part of NF1 feed 27 to facilitate the further recovery of lithium that may have otherwise not been recoverable. In some examples, at least part of a first NF1 Retentate 28 discharged from the NF1 module 26 was combined with the Draw Brine 14 to bolster or maintain the higher osmotic pressure of the Draw Brine In some examples, at least part of the NF1 Retentate 36 was combined with the Draw Brine 14 to facilitate further recovery of lithium that may have otherwise not been recoverable. Movement of water 18 from the Feed Brine 12 across the membrane 20 of the FO1 module 16 simultaneously concentrated the Feed Brine 12 (NFI Permeate 38) to form a Feed Brine Concentrate 22. In some examples, the Feed Brine Concentrate 22 formed was >4-5 times more concentrated that the Feed Brine 14. In some examples, the process involved single or multi-pass nanofiltration (NF) steps or stages, coupled with single or multi-pass forward osmosis (FO) steps or stagfes. In some examples, this addressed at least one issue encountered in lithium processing, as discussed below, and/or increased the overall lithium yield.

With reference to Tables 1-2, FIG. 6-8, in an example, the initial NFI module used in the first stage of the process was used to remove at least some of the divalent ions comprised in the first brine (for example, a brine comprising lithium with a relatively low TDS of about 10,000 to about 30,000 mg/L). The initial NFI module removed upwards of about 80-85% Ca²⁺, about 90-95% Mg²⁺, and/or about 98-99% SO₄²⁻ from the first brine, at an operating pressure of about 80 to about 190 psi. Ion passage results for Ca²⁺, Mg²⁺, and/or SO₄²⁻ obtained for the processing the lower TDS lithium brine (DLE) through the stage 1, initial nanofiltration module (NF1) are shown in FIG. 7. The passage of monovalent cations was found to be in the range of about 85-95%.

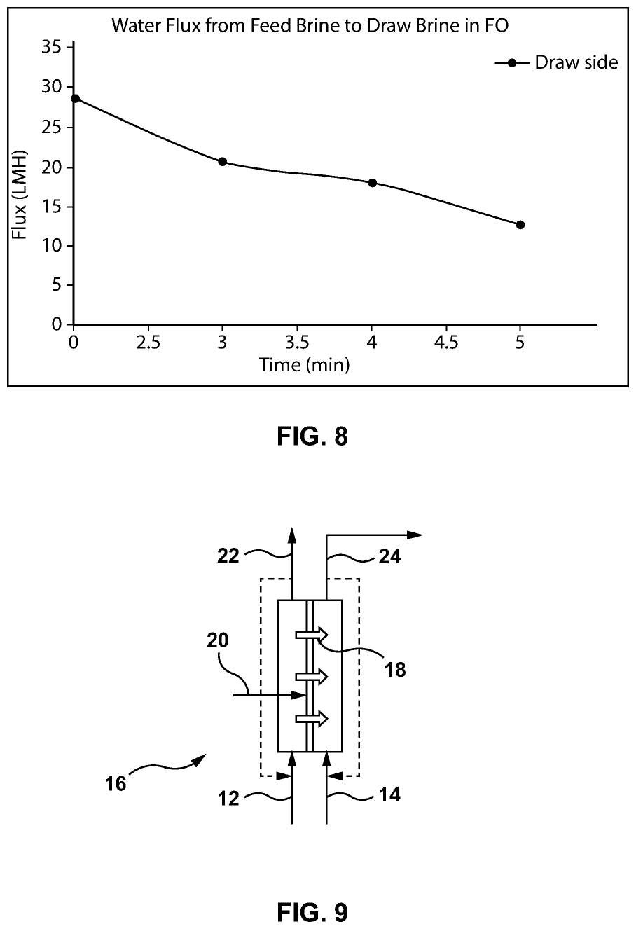

The permeate from NFI, the feed brine, so treated had a resultant TDS between about 9000 to about 28000 mg/L; and was then provided as a feed stream to the first FO1 module. The draw brine comprising lithium had a TDS between about 4 to about 8 lakh mg/L, and was provided as a draw stream to the first FO1 module. With the feed and draw brines so provided to the first FO1 module, the process simultaneously concentrated the feed brine, and the lithium comprises therein, by at least about 4-5 times by removing water (for example, upwards of 90% or more of the water); and diluted the draw brine up to about 2 to about 3 lakh mg/L. The first FO1 module was operated at a pressure of <1-2 bar. Results obtained from the Forward Osmosis (FO1) process are shown in Table 1 & FIG. 8. The results presented in Table 1 show that the FO1 process enriched the lithium in the feed brine by about 6 times its original concentration; and diluted the draw brine by about 50%, to about 2.2 lakh mg/L TDS using water generated through FO process from the feed brine, thereby making the draw brine more treatable via an NF process (such as NF1). Water flux across the FO membrane of FO1 module was found to vary from about 29 LMH to about 13 LMH, as depicted in FIG. 8.

So diluted, the dilute draw brine was further treatable via the downstream first NF1 module. In the second stage of the process depicted in FIG. 6, the first NF1 module was used to further remove at least some of the divalent ions remaining in the dilute draw brine (NF1 Feed). The first NF1 module removed upwards of about 60-65% Ca²⁺, about 80-85% Mg²⁺, and/or about 95-97% SO₄²⁻ that had remained in the dilute draw brine (NF1 feed), at a pressure of about 800 psi. See Table 2. The first NF1 module was also operated at a pressure between about 1200 to about 1400 psi to push overall recovery to about 70%.

The combination of divalent ion removal, feed brine concentration, and/or draw brine dilution and further NF processing facilitated in a higher amount of lithium being yielded and isolated from the first brine and the draw brine. Additional lithium was also recovered from: (i) the initial NFI retentate, by combining that discharged stream with the NF1 feed; and/or (ii) from the NF1 retentate, by combining that discharged stream with the draw brine due to its relatively higher TDS. In some examples, and high osmotic pressure nature or small purge can be removed to get rid of divalent salt precipitation.

TABLE 1
Forward Osmosis process results

| | Lithium-in, | Lithium-out, | TDS-in, | TDS-out, |
|---|---|---|---|---|
| Forward Osmosis Process | mg/L | mg/L | mg/L | mg/L |
| Feed Brine 12 (Lower TDS brine | 1062 | 6665 | 13700 | 76000 |
| comprising lithium as FO feed solution; | | | | |
| e.g., DLE brine) | | | | |
| Drawn Brine 14 (Higher TDS brine | 7485 | 3590 | 458170 | 220000 |
| comprising lithium as FO draw | | | | |
| solution; e.g., 4-5 lakh mg/L TDS brine) | | | | |

TABLE 2
% Ions passage through Nanofiltration
(NF1) module at about 800 psi

| Na | Cl | Li | B | K | Ca | Mg | SO₄ | TDS |
|---|---|---|---|---|---|---|---|---|
| 95-100 | 80-85 | 98-100 | 80-85 | 95-97 | 35-40 | 15-20 | 2-4 | 70-75 |

### DISCUSSION

Demand for lithium continues to increase from battery manufacturers; however, many challenges exist with processing of lithium from different sources. For example, salar brine ponds are a main source of lithium in Latin America. Treating these kinds of brines for lithium recovery generally involves solar evaporation, followed by the purifications steps to make commercial grade lithium. Such processes are generally time consuming, and can result in only about 40-50% overall lithium yield due to (i) loss of lithium via co-precipitation with divalent ions (Ca²⁺, Mg²⁺, SO₄²⁻) and/or with boron, (ii) and due to higher TDS brines comprising lithium, which are generally difficult to process due to their high concentration of dissolved solids. For example, higher TDS brines having a TDS of about 4 to about 8 lakh mg/L can contain concentrations of lithium upwards or about 6000 to about 8000 mg/Lt. However, brines comprising such higher TDS cannot usually be treated by membrane-based processes.

To minimize or avoid loss of lithium due to co-precipitation or un-treatable higher TDS brines, the brines may be diluted to make them more treatable via membrane-based processes, such as to remove divalent ions. However, the location of lithium sources can make this difficult. For example, due to drought climate conditions at salar ponds sites in Latin America, there is minimal availability of water for dilution. As such, there is an impetus to find alternative solutions for fresh-water generation on site of lithium processing. Some solutions considered have included direct lithium extraction (DLE) based technology, a sorption-desorption process for lithium purification. DLE generated an eluent that can be very dilute, and may need further processing like nano-filtration and/or reverse osmosis (RO) and/or thermal evaporation to concentrate it. However, RO has some of its own challenges, such as a TDS limitation (<1 lakh ppm), and higher power consumption which increases with feed TDS.

The method described comprises an NF-FO-NF based method, as depicted in FIG. 6 and demonstrated in FIG. 7-8 and Tables 1-2, that (i) may allow replacement of Reverse Osmosis (RO) membrane-based processes for nano-filtration permeate concentration (for example, Feed Brine; NF1 permeate) with lower pressure processes (for example, such as those used in a typical DLE scheme; forward osmosis); (ii) may allow further processing of nano-filtration retentates (for example, NFI and/or NF1 retentate) for recovery of lithium that would otherwise be unrecoverable; (iii) may facilitate processing of difficult to treat, higher TDS lithium brines, allowing such brines to be used for lithium recovery; (iv) may allow for dilution of higher TDS brines via on-site water generation (for example, via use of FO modules; FO1), allowing such brines to be processed by nano-filtration; and/or (v) may thereby improve overall lithium yields.

Further, the method described comprises an NF-FO-NF based method, as depicted in FIG. 6 and demonstrated in FIG. 7-8 and Tables 1-2, may be used to: (i) dilute difficult to treat, higher TDS lithium brines, thereby improving lithium yield by recovering lithium from a brine that would otherwise be difficult to treat, making the lithium comprised therein difficult to recover; (ii) replace RO-based processes for nano-filtration permeate concentration with lower pressure operations/processes; (iii) utilize nano-filtration retentate to recover more lithium by adding the retentate to feed streams of additional nano-filtration modules; improve overall lithium yield by recovering lithium from nano-filtration retentate(s) and/or by recirculating nano-filtration retentate(s) into FO draw streams to facilitate recovery of lithium from higher TDS, difficult to treat brines.

In an example of the method as described herein, the NF-FO-NF based method, as depicted in FIG. 6 and demonstrated in FIG. 7-8 and Tables 1-2, is employable at salar brine sites to increase final lithium concentrations (for example, increased by >5 times) in lower TDS brines comprising lithium by reducing the brine volume (for example, reduced by >90%), while replacing higher pressure RO-based processes. Further, it is employable at salar brine sites to simultaneously recover lithium from higher TDS brine by diluting the higher TDS brine and making it treatable via nano-filtration. Thus, in an example of the method as described herein, the NF-FO-NF based method is usable to increase/improve overall lithium yields, and reduce overall loss of lithium.

### Example 2—Application of Forward Osmosis (FO) to Reduce Salinity of Relatively High TDS Brines Comprising Lithium

### SUMMARY

Described herein is a method to reduce osmotic pressures of brines comprising lithium and divalent ions to the processability of make such brines via nanofiltration. In an example, the method comprises a Forward Osmosis (FO) module, to which two brines of different TDS levels were provided. One brine was a higher TDS brine comprising lithium and divalent ions (Draw Brine 14). The other brine was a lower TDS brine (Feed Brine 12). Draw Brine 14 had a very high osmotic pressure that could not be processed with conventional NF processes directly because of a high divalent ion concentration. Feed Brine 12 had a lower osmotic pressure than Draw Brine 14. During the FO process, Draw Brine 14 was used as the draw solution, Feed Brine 12 was used as the feed solution, and water flowed from Feed Brine 12 to Draw Brine 14 across a semi-permeable FO membrane 20. During the FO process, the TDS concentration (salinity, divalent ions, etc.) and thus osmotic pressure of the Draw Brine 14 gradually decreased; and the TDS concentration (salinity, divalent ions, etc.) and thus osmotic pressure of the Feed Brine 12 gradually increased. At the end of the FO process, Draw Brine 14, which initially could not be processed via nano-filtration (NF) because of its higher osmotic pressure (for example, contributed to by a higher divalent ion concentration), was converted to Dilute Draw Brine 24 and more amenable to further treatment by NF.

### Results

Described is a method of treating brines comprising lithium having a relatively high TDS (for example, a very high salinity) that is in part contributed to by a higher concentration of divalent ions. Divalent ions generally present in such brines includes Ca²⁺, Mg²⁺, and/or SO₄²⁻. Generally, nano-filtration (NF) can be used to separate these divalent ions from lithium comprised within brines. However, divalent ions can create an osmotic pressure that must be overcome during nano-filtration. If the concentration of divalent ions creates an osmotic pressure higher than the operable osmotic pressure of a nano-filtration membrane or module, brines comprising that concentration of divalent ions cannot be treated or processed by nano-filtration.

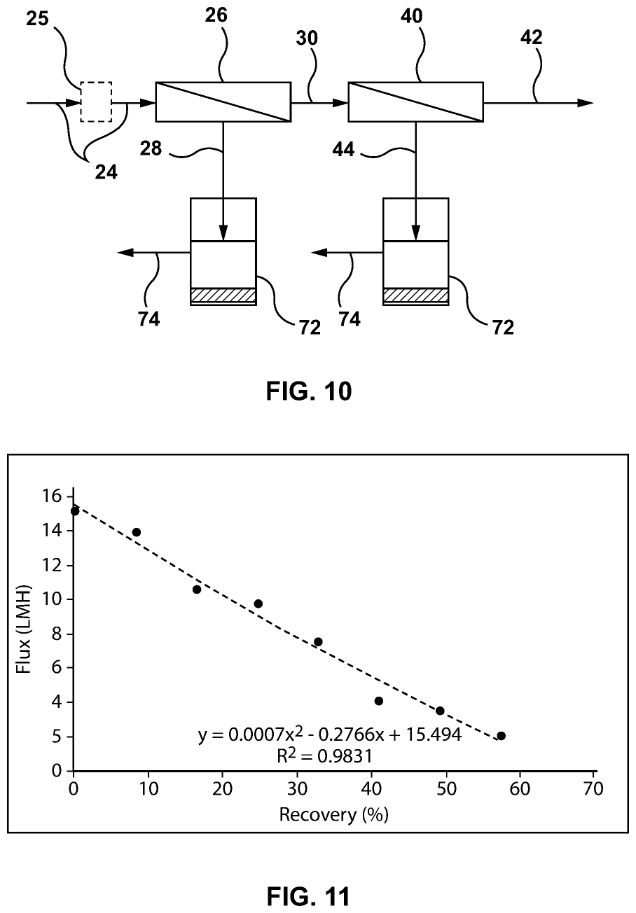

With reference to Tables 3-4, FIG. 9, in an example, the method described reduced osmotic pressures of a brine comprising a high divalent ion concentration, to make the brine amenable to processing by nano-filtration. The method comprised a Forward Osmosis (FO) module (FO1 module 16), to which were provided two brines of different TDS level (see Table 3). The Feed Brine 12 comprised a relatively high TDS (for example, a very high salinity and divalent ion concentration). The Draw Brine 14, comprised a relatively low TDS (for example, a lower salinity content). Due to its higher TDS (including higher divalent ion concentration), Draw Brine 14 had a high Osmotic Pressure, such that it could not be otherwise processed with conventional NF membranes and modules. Due to its lower TDS, Feed Brine 12 had a lower Osmotic Pressure than Draw Brine 14. During the FO process, Draw Brine 14 was used as a FO draw solution, Feed Brine 12 is used as an FO feed solution, and water 18 flowed from Feed Brine 12 to Draw Brine 14 across an FO membrane 20 in FO module (FO1 module 16). During the FO process, the TDS concentration (salinity, divalent ions, etc.) and thus osmotic pressure of Draw Brine 14 gradually decreased, while that of Feed Brine 12 gradually increased. At the end of the FO process, Draw Brine 14 was diluted and formed Dilute Drawn Brine 24 (see Table 4), which was then diverted to a NF module for further treatment by nano-filtration (see FIG. 10). At the end of the FO process, Feed Brine 12 was concentrated and formed a Feed Brine Concentrate 22, which could be further processed in evaporation ponds or by other methods.

With reference to FIG. 9, in an example, the method described may comprise increasing temperatures of the Draw Brine 14 or Feed Brine 12 or both to increase solubility of some salts dissolved in the respective brines, to further facilitate the FO process. Such an increase in solubility may minimize or prevent precipitation in Feed Brine 12. An increase in temperature may also facilitate movement of water 18 across the FO membrane 20, and facilitate further concentration of Feed Brine 12 and further dilution of Draw Brine 14, than may be possible at lower temperatures. The heat energy may be recovered with a heat exchanger.

With reference to FIG. 10, the method described also comprised a single or multi-pass nano-filtration process involving single or multiple NF modules to further process Dilute Draw Brine 24 by separating divalent ions (calcium, magnesium, sulfate etc.) from the lithium comprised therein. Where the method comprised a multi-pass nano-filtration, the first nano-filtration module (NF1 module 26) comprised a membrane having a lower rejection property for divalent ions, with subsequent nano-filtration modules having a progressively higher rejection property (for example, NF2 module 40, NF3, NF4), such that the divalent ion rejection properties were NF1<NF2<NF3<NF4 (NF3 and NF4 not shown). At least some of the NF modules used were able to operate at a higher pressure (up to about 1400 psi) than typical nano-filtration modules, which can be limited to about 80 psi. Optionally, the Dilute Draw Brine 24 may pass through a pre-treatment module 25 before entering NF1 module 26.

With continued reference to FIG. 10, the operating pressure for the nano-filtration (NF) processes depended, at least in part, on the divalent ion concentrations (and consequent osmotic pressure generated) in Dilute Draw Brine 24, and the rejection property of the NF membrane used in the NF modules. It was found that, for the same feed stream (for example, Dilute Draw Brine 24) having a particular divalent ion concentration, NF membranes with a higher rejection for divalent ions required higher operating pressures to filter the feed stream. Many NF membranes used in incumbent NF processes have a maximum pressure tolerance of about 800 psi. NF membranes have been developed that have lower rejection properties, but that can operate at higher pressures (for example, up to 1400 psi). Such membranes having higher pressure tolerances may be used to treat brines that cannot be treated using membranes having lower pressure tolerances, or that may not otherwise be treatable by membrane-based processes. The method described used an NF membrane in the NF1 module 26 that had lower rejection properties and higher pressure tolerances; and as such, the NF1 module 26 at least partially separated calcium, magnesium and sulfate divalent ions from the Dilute Drawn Brine 24 (a brine with high concentrations of these divalent ions). It was found that use of such lower rejection/higher pressure membranes in NF modules of the method described allowed for the at least partial treatment of brines comprising sulfate concentrations as high as 30,000 ppm or more, and/or magnesium as high as 20,000 ppm. To further reduce the divalent ion concentration in the NF1 module 26—treated Dilute Draw Brine 24 before final processing, the NF1 Permeate 30 was provided to a second NF module (NF2 module 40), comprising a membrane with higher rejection properties than the NF1 module 26, for further NF treatment. Additional, subsequent NF modules downstream of NF2 module 40 were optionally used, each having a membrane with higher rejection properties than the modules upstream.

At least a part of the respective NF retentates 28, 44 from the multipass NF process were optionally provided to FO1 module 16 or another FO module to act as draw solutions, to reduce their TDS levels (for example, salinity), and again make the retentates amenable to the NF process. In this way, it was possible to recover further lithium from the NF retentates. Alternatively, at least a part of the retentate from the NF2 module (NF2 Retentate 44) was optionally provided back to the NF1 module 26 as part of its feed stream. Alternatively, at least a part of the retentates from both modules NF1 and NF2 (NF1 Retentate 28, NF2 retentate 44) were optionally sent to evaporation ponds 72, where the brines could be subject to further precipitation, either via solar evaporation or via chemical addition. Any brines resulting from this treatment (evaporation pond supernatant 74) comprising a lower TDS or divalent ion concentration could again be treated with nano-filtration.

With reference to FIG. 11, a test was conducted that showed around 58% recovery through a first NF module (NF1) at a pressure of 1300 psi for the diluted draw brine; and with reference to the brine compositions shown in Table 3, >50% dilution of draw brine 1 can be possible through Forward Osmosis at 15-30 Psi pressure (Table 4)

TABLE 3
Composition of Draw Brine 1 and Feed Brine 2

| | Ca, | Mg, | SO₄, | Na, | Cl, | Li, | K, | TDS, |
|---|---|---|---|---|---|---|---|---|
| | mg/l | mg/l | mg/l | mg/l | mg/l | mg/l | mg/l | mg/l |
| Draw Brine 14 | <1 | 34300 | 37580 | 33140 | 137500 | 200 | 15625 | 260000 |
| Feed Brine 12 | 580 | 22 | <1 | 11175 | 23750 | 10 | 2717 | 40000 |

TABLE 4
Composition of Dilute Draw Brine 1 after FO Process

| | Ca, | Mg, | SO₄, | Na, | Cl, | Li | K, | TDS, |
|---|---|---|---|---|---|---|---|---|
| | mg/l | mg/l | mg/l | mg/l | mg/l | mg/l | mg/l | mg/l |
| Draw Brine 14 | <1 | 17000 | 19000 | 16500 | 70000 | 100 | 8000 | 130600 |

### Discussion

The Salars in South America are among some of the major sources of lithium globally. Generally, isolating lithium from the Salar brines comprising lithium involves a process of evaporation to reduce the volume of brine, thereby triggering a precipitation of salts to remove other impurities, such as divalent ions. Typically, the evaporation process is a lengthy process. Moreover, it has been found that the evaporation and precipitation processes tend not to remove enough of the divalent ions to reduce their concentrations to sufficiently low levels for further, membrane-based processing. For example, following evaporation and precipitation, the divalent ion concentrations in the remaining brines are often too high for nano-filtration membranes. Nano-filtration membranes tend to be limited in terms of their operating pressures, based on the osmotic pressure of their feed brine streams. When the osmotic pressure of the NF feed brine stream exceeds the allowable or operational limits of the nano-filtration membrane due to divalent ion concentrations, it becomes practically impossible to use nano-filtration to remove divalent ions from feed brines. As such, further purification has often been found to be necessary, and these subsequent purification processes have resulted in a loss of lithium, leading to reduced recovery.

Occasionally, there are waste brine streams in the Salars which have a high lithium content, but further processing is not possible because of the higher TDS levels (for example, higher divalent ion concentration and high salinity). Many incumbent nanofiltration membranes cannot operate when sulfate (SO₄²⁻) concentrations exceed about 20,000 ppm, and/or magnesium (Mg²⁺) concentrations exceed about 20,000 ppm, and/or calcium (Ca²⁺) concentration exceeds about 1,000 ppm. To treat brines with such high divalent ion concentrations via membrane-based processes, osmotic pressure requirement is often >1200 Psi. Therefore, to make these brines treatable with a lower pressure tolerate NF membrane, the divalent ion concentration must be reduced by dilution or other means. However, the Salars are often located in remote areas where there is no source of water readily available to dilute such high TDS, high salinity brines with a high divalent ion concentration. As a result, methods like ion exchange or direct extraction, which require significant clean water, are often considered not practical.

In contrast, the method described herein may (i) reduce TDS levels, salinity of brines comprising lithium that would not otherwise be treatable by nano-filtration modules and membranes (for example, Draw Brine 1) and allow use of nano-filtration for further processing of these brines; (ii) allow lithium recovery from the brines which would otherwise be left as a waste product; (iii) use brines already available in the Salars; (iv) increase TDS levels, salinity of lower TDS brines comprising lithium (for example, Feed Brine 2), thereby reducing the evaporation time required for further processing; (v) reduce lithium loss from lithium purification and extraction processes; and/or (vi) increase overall lithium yield and/or recovery.

### Example 3—Application of Nano-Filtration (NF)—Forward Osmosis (FO)—Nano-Filtration (NF) for Lithium Recovery

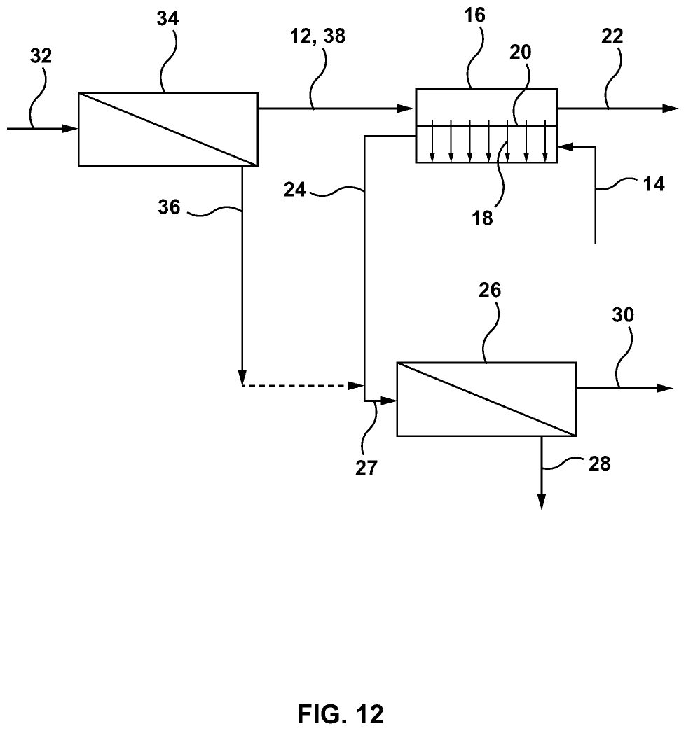

With reference to FIG. 12, in an example, a method is described involving processing a brine comprising lithium through an initial nano-filtration module (NFI module 34), a first forward osmosis module (FO1 module 16), and a first NF module (NF1 module 26). With reference to Table 5, the operating parameters of the method are provided. Lithium yields obtained from the NFI module 34 and first FO1 module 16 were about 90%, respectively. Lithium yields obtained from the NF1 module 26 was about 70%.

TABLE 5
Operating Parameters of Method as Depicted in FIG. 12.

| Component/Step | Conditions |
|---|---|
| First Brine 32 | Flow rate: (1 m³/hr) |
| | Exemplified First Brine: DLE brine |
| | Li Concentration: 1.23 kg/hr (1233 mg/L) |
| | TDS: 12k mg/L |
| Initial NF Module, NFI | Process recovery: 95% [calculated as (permeate |
| module 34 | volume/feed volume)*100)] |
| | Pressure: 130 psi |
| Feed Brine 12/NFI | Flow rate: (0.95 m³/hr) |
| Permeate 38 | Li Concentration: 1.11 kg/hr (1168 mg/L) |
| | TDS: 11.2k mg/L |
| | Li Yield: 90% |
| NFI Retentate 36 | Flow rate: (0.05 m³/hr) |
| | Li Concentration: 1777 mg/L |
| | TDS: 26k mg/L |
| First FO Module, FO1 | Process recovery: 75% [calculated as (water permeate (feed to |
| module 16 | draw) volume/feed volume)*100] |
| | Calculated Osmotic Pressure Ratio, Draw:Feed: = 23.43 |
| Feed Brine | Flow rate: (0.24 m³/hr) |
| Concentrate 22, from | Li Concentration: 1.11 kg/hr (4670 mg/L) |
| FO1 module 16 | TDS: 44.8k mg/L |
| | Calculated Osmotic Pressure: 184 PSI |
| | Li Yield: 90% |
| | Downstream Steps: Further concentration & purification |
| Draw Brine 14, to FO1 | Flow rate: (0.95 m³/hr) |
| module 16 | Exemplified Draw Brine: High TDS waste raw brine, |
| | comprising high concentrations of Ca²⁺, Mg²⁺, and SO₄²⁻ |
| | ions, high TDS, with dilution required for NF processing, |
| | and no water on-site for dilution |
| | Calculated Osmotic Pressure: 4312 PSI |
| | Li Concentration: 6.46 kg/hr (6800 mg/L) |
| | TDS: ~4.0-4.5 lakh mg/L |
| Dilute Draw Brine 24, | Flow rate: (1.66 m³/hr) |
| from FO1 module 16 | Li Concentration: 6.46 kg/hr (3885 mg/L) |
| | TDS: 2.5 lakh mg/L |
| First NF Module, NF1 | Process recovery: 70% [calculated as (permeate |
| module 26 | volume/feed volume)*100)] |
| | Pressure: 1400-1500 psi |
| NF1 Feed 27 | Flow rate: (1.66 m³/hr) |
| | Exemplified Draw Brine: Dilute Draw Brine and optionally |
| | NFI Retentate |
| | Li Concentration: 6.46 kg/hr (3885 mg/L) |
| | TDS: 2.5 lakh mg/L |
| NF1 Permeate 30 | Flow rate: (1.16 m³/hr) |
| | Li Concentration: 4.52 kg/hr (3885 mg/L) |
| | TDS: 2 lakh mg/L |
| | Li Yield: 70% |
| | Downstream Steps: Further concentration & purification |
| NF1 Retentate 28 | Flow rate: (0.5 m³/hr) |
| | Li Concentration: 1.6 kg/hr (3100 mg/L) |
| | TDS: 3.2-3.4 lakh mg/L |
| | Downstream Steps: Available for mixing with Draw Brine |

Purging was required before saturation limits of salts

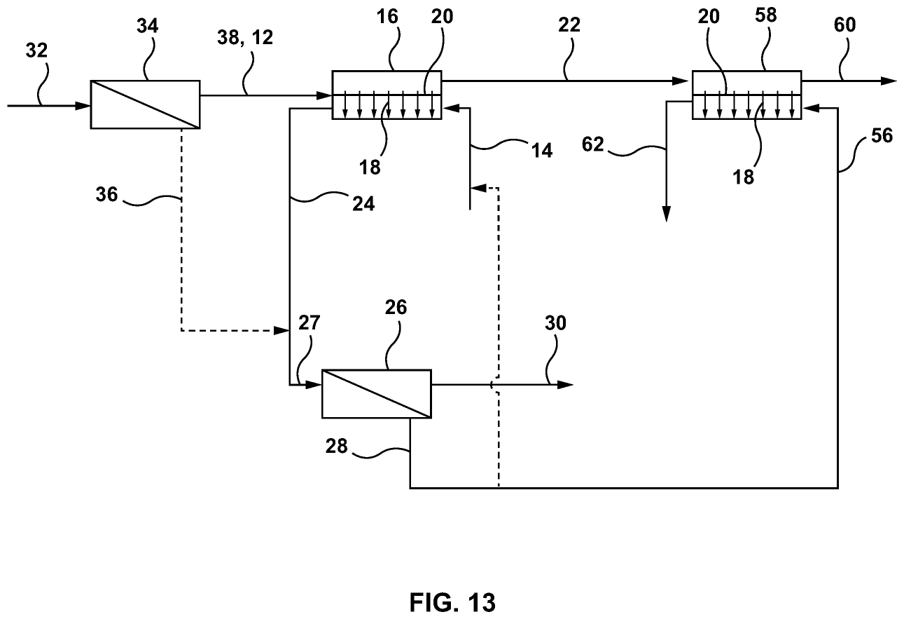

With reference to FIG. 13, in an example, a method is described involving processing a brine comprising lithium through an initial nano-filtration module (NFI module 34), a first forward osmosis module (FO1 module 16), a first NF module (NF1 module 26), and a second FO module (FO2 module 58). With reference to Table 6, the operating parameters of the method are provided.

TABLE 6
Operating Parameters of Method as Depicted in FIG. 13.

| Component/Step | Conditions |
|---|---|
| First Brine 32 | Flow rate: (1 m³/hr) |
| | Exemplified First Brine: DLE brine, comprising lower Ca |
| | & Mg levels that eventually increased throughout |
| | process/recovery, and lower Li concentration, requiring |
| | further concentration |
| | Li Concentration: 1.23 kg/hr (1233 mg/L) |
| | TDS: 12k mg/L |
| Initial NF Module, NFI | Process recovery: 96% [calculated as (permeate |
| module 34 | volume/feed volume)*100)] |
| | Pressure: 130 psi |
| Feed Brine 12/NFI | Flow rate: (0.95 m3/hr) |
| Permeate 38 | Li Concentration: 1.11 kg/hr (1168 mg/L) |
| | TDS: 11.2k mg/L |
| | Li Yield: 90% |
| NFI Retentate 36 | Flow rate: (0.05 m³/hr) |
| | Li Concentration: 1777 mg/L |
| | TDS: 26k mg/L |
| First FO Module, FO1 | Process recovery: 75% [calculated as (water permeate (feed to |
| module 16 | draw) volume/feed volume)*100] |
| Feed Brine | Flow rate: (0.24 m³/hr) |
| Concentraten22, from | Li Concentration: 1.11 kg/hr (4670 mg/L) |
| FO1 module 16 | TDS: 44.8k mg/L |
| | Calculated Osmotic Pressure: 184 PSI |
| | Li Yield: 90% |
| | Downstream Steps: Further concentration through FO2 |
| | Concentrated 4x relative to Feed Brine |
| Draw Brine 14, to FO1 | Flow rate: (0.95 m³/hr) |
| module 16 | Exemplified Draw Brine: High TDS waste raw brine, |
| | comprising high concentrations of Ca²⁺, Mg²⁺, and SO₄²⁻ |
| | ions, high TDS, with dilution required for NF processing, |
| | and no water on-site for dilution |
| | Calculated Osmotic Pressure: 4312 PSI |
| | Li Concentration: 6.46 kg/hr (6800 mg/L) |
| | TDS: ~4.5 lakh mg/L |
| Dilute Draw Brine 24, | Flow rate: (1.66 m3/hr) |
| from FO1 module 16 | Li Concentration: 6.46 kg/hr (3885 mg/L) |
| | TDS: 2.5 lakh mg/L |
| First NF Module, NF1 | Process recovery: 70% [calculated as (permeate |
| module 26 | volume/feed volume)*100)] |
| | Pressure: 1400-1500 psi |
| NF1 Feed 27 | Flow rate: (1.66 m³/hr) |
| | Exemplified Draw Brine: Dilute Draw Brine and |
| | optionally NFI Retentate |
| NF1 Permeate 30 | Flow rate: (1.16 m³/hr) |
| | Li Concentration: 4.52 kg/hr (3885 mg/L) |
| | TDS: 2 lakh mg/L |
| | Li Yield: 70% |
| | Downstream Steps: Further concentration & purification |
| NF1 Retentate 28 | Flow rate: (0.5 m³/hr) |
| | Li Concentration: 1.6 kg/hr (3100 mg/L) |
| | TDS: 3.2-3.4 lakh mg/L |
| | Downstream Steps: Available for mixing with Draw |
| | Brine and First Draw Solution |
| Second FO Module, | Process recovery: 50% [calculated as (water permeate |
| FO2 module 58 | (feed to draw) volume/feed volume)*100] |
| First Draw Solution 56, | Flow rate: (0.24 m³/hr) |
| to FO2 module 58 | Exemplified Draw Solution: NF1 Retentate |
| | Li Concentration: 0.74 kg/hr (3100 mg/L) |
| | TDS: 3.0 lakh mg/L |
| First FO Diluted Draw | Flow rate: (0.36 m³/hr) |
| 62, from FO2 module | Li Concentration: 0.74 kg/hr (2066 mg/L) |
| 58 | TDS: 2.0 lakh mg/L |
| | Downstream Steps: Available for mixing with NF1 Feed |
| First FO Concentrate | Flow rate: (0.12 m³/hr) |
| 60, from FO2 module | Li Concentration: 1.11 kg/hr (9341 mg/L) |
| 58 | TDS: 89.65k mg/L |
| | Li Yield: 90% |
| | Concentrated ~2x relative to Feed Brine Concentrate |

Purging was required before saturation limits of salts

### Example 4—Application of Nano-Filtration (NF)—Forward Osmosis (FO)—Nano-Filtration (NF) for Lithium Recovery (with Feed Brine TDS Around 240,000 mg/L)

With reference to FIG. 12, in an example, a method is described involving processing a brine comprising lithium through an initial nano-filtration module (NF), a first forward osmosis module (FO1), and a first NF module (NF1). With reference to Table 7, the operating parameters of the method are provided. Lithium yields obtained from the initial NFI module and first FO1 module were about 70%, and 50% respectively. Lithium yields obtained from the first NF module was about 60%.

TABLE 7
Operating Parameters of Method as Depicted in FIG. 12.

| Component/Step | Conditions |
|---|---|
| First Brine 32 | Flow rate: (1 m³/hr) |
| | Exemplified First Brine: Salar brine |
| | Li Concentration: 3.49 kg/hr (3494 mg/L) |
| | TDS: 240k mg/L |
| Initial NF Module, NFI | Process recovery: 70% [calculated as (permeate |
| module 34 | volume/feed volume)*100)] |
| | Pressure: 1600 psi |
| Feed Brine 12/NFI | Flow rate: (0.7 m³/hr) |
| Permeate 38 | Li Concentration: 2.8 kg/hr (4000 mg/L) |
| | TDS: 160k mg/L |
| | Li Yield: 80% |
| NFI Retentate 36 | Flow rate: (0.3 m³/hr) |
| | Li Concentration: 3200 mg/L |
| | TDS: 300k mg/L |
| First FO Module, FO1 | Process recovery: 40-50% [calculated as (water permeate (feed |
| module 16 | to draw) volume/feed volume)*100] |
| | Calculated Osmotic Pressure Ratio, Draw:Feed: = 2.5 |
| Feed Brine | Flow rate: (0.42 m³/hr) |
| Concentrate 22, from | Li Concentration: 2.8 kg/hr (6664 mg/L) |
| FO1 module 16 | TDS: 220k mg/L |
| | Calculated Osmotic Pressure: 1773 PSI |
| | Li Yield: 80% |
| | Downstream Steps: Further concentration & purification |
| Draw Brine 14, to FO1 | Flow rate: (0.7 m³/hr) |
| module 16 | Exemplified Draw Brine: High TDS waste raw brine, |
| | comprising high concentrations of Ca²⁺, Mg²⁺, and SO₄²⁻ |
| | ions, high TDS, with dilution required for NF processing, |
| | and no water on-site for dilution |
| | Calculated Osmotic Pressure: 4312 PSI |
| | Li Concentration: 4.76 kg/hr (6800 mg/L) |
| | TDS: ~4.0-4.5 lakh mg/L |
| Dilute Draw Brine 24, | Flow rate: (0.98 m³/hr) |
| from FO1 module 16 | Li Concentration: 4.76 kg/hr (4857 mg/L) |
| | TDS: 2.5 lakh mg/L |
| First NF Module, NF1 | Process recovery: 60% [calculated as (permeate |
| module 26 | volume/feed volume)*100)] |
| | Pressure: 1600 psi |
| NF1 Feed 27 | Flow rate: (0.98 m³/hr) |
| | Exemplified Draw Brine: Dilute Draw Brine and optionally |
| | NFI Retentate |
| | Li Concentration: 4.76 kg/hr (4857 mg/L) |
| | TDS: 2.5 lakh mg/L |
| NF1 Permeate 30 | Flow rate: (0.59 m³/hr) |
| | Li Concentration: 2.86 kg/hr (4857 mg/L) |
| | TDS: 2.0 lakh mg/L |
| | Li Yield: 60% |
| | Downstream Steps: Further concentration & purification |
| NF1 Retentate 28 | Flow rate: (0.39 m³/hr) |
| | Li Concentration: 1.5 kg/hr (3800 mg/L) |
| | TDS: 3.0-3.4 lakh mg/L |
| | Downstream Steps: Available for mixing with Draw Brine |

Purging was required before saturation limits of salts

### Example 5—Application of Forward Osmosis (FO) after Nano-Filtration (NF) for Lithium Recovery

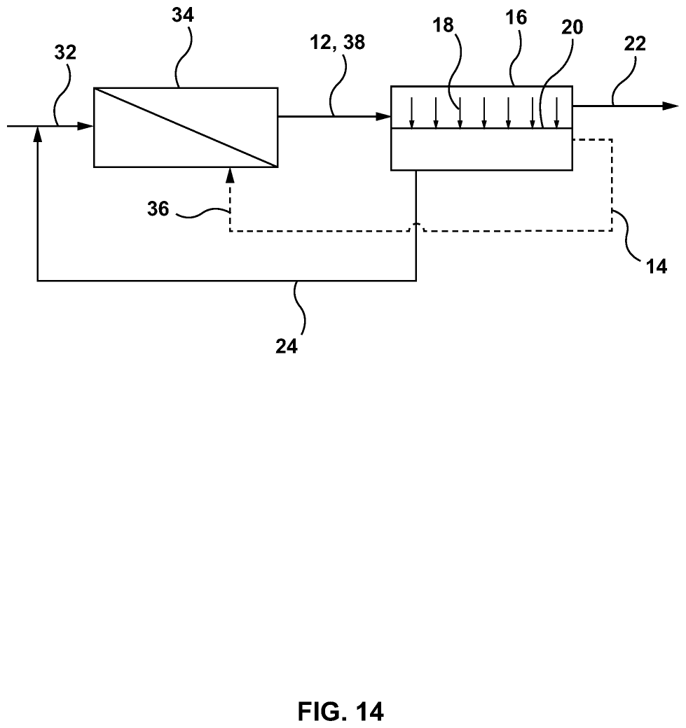

With reference to FIG. 14, in an example, a method is described involving feeding a High TDS waste Brine (First Brine 32) through an initial nano-filtration module (NFI module 34), followed by a forward osmosis module (FO1 module 16). NFI retentate 36 from the NFI module 34 was used as a Draw Brine 14 for the FO1 module 16 due to a higher osmotic pressure, in part because of a higher divalent ion concentration. Permeate from the NF module (NFI Permeate 38) was used as a Feed Brine 12 for the FO1 module 16. Following being provided to the FO1 module 16, water 18 passed through a FO membrane 20 of the FO1 module 16 from the lower concentration Feed Brine 12 to the higher concentrated Draw Brine 14. With reference to Table 8, the osmotic pressures calculated for the Draw Brine 14 or NFI Retentate 36, and Feed Brine 12, after a high TDS waste brine diluted 4× NF run, and a 10× NF run are provided over % Process Recoveries (Recovery) of 0-75% [calculated as (permeate volume/feed volume)*100)].

TABLE 8
Operating Pressures of Brines and Retentates from Method as Depicted in FIG. 14.

| | High TDS waste brine | | High TDS waste brine | |
|---|---|---|---|---|
| | diluted 4X NF run | | diluted 10X NF run | |
| | Draw Brine 14 or NFI | | Draw Brine 14 or NFI | |
| | Retentate 36 pressure, | Feed Brine 32 | Retentate 36 pressure, | Feed Brine 32 |
| Recovery | Psi | pressure, Psi | Psi | pressure, Psi |
| 0% | 953 | 577 | — | — |
| 20% | 948 | 646 | 454 | 187 |
| 40% | 1098 | 701 | 440 | 182 |
| 60% | 1131 | 723 | 595 | 296 |
| 75% | — | — | 607 | 268 |

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

The invention claimed is:

1. A method of processing brine comprising lithium, the method comprising
providing a feed brine and a draw brine to a first forward osmosis (FO) module, the feed brine and/or the draw brine comprising lithium, and
forming a feed brine concentrate and a dilute draw brine; and
providing the dilute draw brine to a first nanofiltration (NF) module, and
forming a first NF retentate, at least a portion of which is optionally recycled to the FO module, and
forming a first NF permeate comprising at least a portion of the lithium.

2. The method of claim 1, further comprising:
providing a first brine to an initial NF module that is upstream of the first FO module, and
forming the feed brine that is provided to the first FO module, and
forming an initial NF retentate, at least a portion of which is optionally recycled to the first FO module and/or the first NF module.

3. The method of claim 1, further comprising:
providing the first NF permeate to a second NF module downstream of the first NF module, and
forming a second NF permeate comprising at least a portion of the lithium, and
forming a second NF retentate, at least a portion of which is optionally recycled upstream and/or downstream of the second NF module.

4. The method of claim 3, further comprising:
providing the second NF permeate to one or more subsequent NF modules downstream of the second NF module, and
forming a subsequent NF permeate comprising at least a portion of the lithium, and
forming a subsequent NF retentate, at least a portion of which is optionally recycled upstream and/or downstream of the one or more subsequent NF modules.

5. The method of claim 1, further comprising:
providing the feed brine concentrate as a feed solution to a second FO module downstream of the first FO module,
providing a first draw solution to the second FO module, at least a portion of the draw solution being optionally recycled from upstream of the second FO module; and
forming a first FO concentrate comprising at least a portion of the lithium, and
forming a first FO diluted draw, at least a portion of which is optionally recycled to an NF module upstream and/or downstream of the second FO module.

6. The method of claim 5, further comprising:
providing the first FO concentrate to one or more subsequent FO modules downstream of the second FO module, and
providing a second draw solution to the one or more subsequent FO modules, at least a portion of the draw solution being optionally recycled from upstream of the one or more subsequent FO modules; and
forming a subsequent FO concentrate comprising at least a portion of the lithium, and
forming a subsequent FO diluted draw, at least a portion of which is optionally recycled to an NF module upstream and/or downstream of the one or more subsequent FO modules.

7. The method of claim 1, wherein providing a feed brine to the first FO module comprises:
providing a first brine to the first NF module, and
forming the first NF permeate that is the feed brine provided to the first FO module, and
forming the first NF retentate that is the draw brine, at least a portion of which is provided to the first FO module.

8. The method of claim 1, wherein the draw brine comprises lithium.

9. The method of claim 1, wherein the feed brine comprises lithium.

10. The method of claim 1, wherein the feed brine and the draw brine comprise lithium.

11. The method of claim 2, wherein the first brine comprises lithium.

12. The method of claim 1, wherein the draw brine comprises:
a total dissolved solids (TDS) of at least 100,000 mg/L;
a TDS between about 100,000 mg/L and about 1,000,000 mg/L, such as between about 400,000 mg/L and about 800,000 mg/L;
a salar brine;
lithium at a concentration of at least at least 1 mg/L, such as at least 10 mg/L, or at least 100 mg/L;
lithium at a concentration between about 100 mg/L to about 10,000 mg/L, such as between about 6000 mg/L to about 8000 mg/L;
divalent ions, such as Ca²⁺, Mg²⁺, SO₄²⁻;
divalent ions Ca²⁺, Mg²⁺, and/or SO₄²⁻ at concentrations of at least 300 mg Ca²⁺ per L, at least 1000 mg of Mg²⁺ per L, and/or at least 500 mg of SO₄²⁺ per L;
about 300 to about 2,000 mg/L of Ca²⁺; about 1000 to about 60,000 mg/L of Mg²⁺; and/or about 500 to about 65,000 mg/L or more of SO₄²⁻;
or any combination thereof.

13. The method of claim 1, wherein the feed brine comprises:
a total dissolved solids (TDS) of less than 250,000 mg/L or less than 50,000 mg/L;
a TDS between about 10,000 mg/L and about 200,000 mg/L, such as between about 10,000 mg/L and about 100,000 mg/L or between about 10,000 mg/L and about 50,000 mg/L, such as between about 10,000 mg/L and about 30,000 mg/L;
a high TDS Latin America Salar brine;
a Cerro Prieto geothermal brine;
a sea water brine;
a DLE brine;
lithium at a concentration of at least 10 mg/L;
lithium at a concentration between about 10 mg/L to about 6000 mg/L or between about 10 mg/L to about 2300 mg/L;
divalent ions, such as Ca⁺², Mg⁺² SO₄⁻²;
divalent ions Ca⁺², Mg⁺², and/or SO₄⁻² at concentrations of at least 5 mg Ca⁺² per L, at least 3 mg of Mg⁺² per L, and/or at least 1 mg of SO₄⁻² per L;
about 5 to about 100 mg Ca⁺² per L, about 3 to about 50 mg of Mg⁺² per L, and/or about 1 to about 15 mg of SO₄⁻² per L;
about 800 mg/L or less of Ca⁺²; 10,000 mg/L or less or 1300 mg/L or less of Mg⁺²; and/or 15,000 mg/L or less or 2700 mg/L or less of SO₄⁻² or any combination thereof.

14. The method of claim 2, wherein the first brine comprises:
a total dissolved solids (TDS) of less than 250,000 mg/L or less than 50,000 mg/L;
a TDS between about 10,000 mg/L and about 250,000 mg/L, such as between about 10,000 mg/L and about 240,000 mg/L, or between about 10,000 mg/L and about 100,000 mg/L, or between about 10,000 mg/L and about 50,000 mg/L, or between about 10,000 mg/L and about 40,000 mg/L, or between about 10,000 mg/L and about 30,000 mg/L;
a high TDS Latin America Salar brine;
a Cerro Prieto geothermal brine;
a sea water brine;
a DLE brine;
lithium at a concentration of at least 10 mg/L;
lithium at a concentration between about 10 mg/L to about 6000 mg/L or between about 10 mg/L to about 2300 mg/L;
divalent ions, such as Ca⁺², Mg⁺², SO₄⁻²;
divalent ions Ca⁺², Mg⁺², and/or SO₄⁻² at concentrations of at least 40 mg Ca⁺² per L, at least 10 mg of Mg⁺² per L, and/or at least 0.1 mg of SO₄⁻² per L;
about 1000 mg/L or less or 800 mg/L or less of Ca⁺²; 25,000 mg/L or less or 1300 mg/L or less of Mg⁺²; and/or 25,000 mg/L or less or 2700 mg/L or less of SO₄⁻² about 100 to about 800 or 1000 mg/L Ca⁺²; or about 10 to about 60 mg/L Mg⁺², and/or about 0.1 to about 50 mg/L SO₄⁻²;
or any combination thereof.

15. The method of claim 1, wherein providing the dilute draw brine to the first nanofiltration (NF) module comprises operating the first and/or second NF module:
at a pressure of up to 800 psi, or up to 1500 or 1600 psi;
at a pressure between about 80 psi to about 1500 or 1600 psi, such as between about 800 psi to about 1300 or 1600 psi;
at a recovery of about 50-70% to about 75%;
at a recovery of about 50-70% to about 75%, at a pressure between about 1300 psi and about 1600 psi or between about 1300 psi and about 1400 psi;
with a membrane that rejects between about 50% to about 99% of Ca²⁺, Mg²⁺, and/or SO₄²⁻;
with a membrane that rejects about 80% to about 85% of Ca²⁺, about 90% to about 95% of Mg²⁺, and/or about 97% to about 99% of SO₄²⁻;
with a membrane that rejects about 50% to about 60% of Ca²⁺, about 80% to about 85% of Mg²⁺, and/or about 97% to about 99% of SO₄²⁻; or
a combination of two or more.

16. The method of claim 1, wherein providing the first brine to the initial nanofiltration (NF) module comprises operating the initial NF module:
at a pressure between about 80 psi to about 1500 or 1600 psi;
at a pressure of about 130 psi;
an average flux of about 11-21 LMH;
an average flux of about 11-21 LMH, at a pressure of about 130-1600 psi;
with a high recovery membrane;
with a membrane that rejects between about 80% to about 99% of Ca²⁺, Mg²⁺, and/or SO₄²⁻;
with a membrane that rejects about 80% to about 85% of Ca²⁺, about 90% to about 95% of Mg²⁺, and/or about 97% to about 99% of SO₄⁻² or any combination thereof.

17. The method of claim 1, wherein providing the feed brine and the draw brine to the first forward osmosis (FO) module comprises operating the first FO module:
at a pressure between about 15 psi and about 30 psi;
at a pressure between about 15 psi and about 30 psi, when the FO membrane has an area of about 13.8 m²;
an average flux of about 20 LMH or an average flux of about 10-11 LMH (with high TDS Latin American brine);
an average flux of about 20 LMH, at a pressure between about 15 to about 30 psi or an average flux of about 10-11 LMH, at a pressure between about 15 to about 30 psi;
with a membrane configured to reject ≥99% of salts;
with a membrane configured to reject ≥99% of salts at a pressure between about 15 psi and about 30 psi;
at a recovery up to about 75% or greater than 75% or at a recovery up to about 40% or greater than 60%;
with a hollow fiber membrane;
with a hollow fiber membrane configured to reject ≥99% of salts;
with a hollow fiber membrane configured to reject ≥99% of salts at a pressure between about 15 to about 30 psi; or
any combination thereof.

18. The method of claim 1, wherein providing to the second forward osmosis (FO) module and/or subsequent FO modules comprises operating the FO modules:
at a pressure between about 15 psi and about 30 psi;
an average flux between about 10 to about 15 LMH;
an average flux between about 10 to about 15 LMH, at a pressure between about 15 to about 30 psi;
with a membrane configured to reject ≥99% of salts;
with a membrane configured to reject ≥99% of salts at a pressure between about 15 psi and about 30 psi;
at a recovery up to about 40% or greater than 50%;
with a hollow fiber membrane;
with a hollow fiber membrane configured to reject ≥99% of salts;
with a hollow fiber membrane configured to reject ≥99% of salts at a pressure between about 15 to about 30 psi; or
any combination thereof.

19. The method of claim 1, wherein the feed brine, draw brine, or first brine is free of makeup water, makeup aqueous solutions, or a combination thereof.

20. The method of claim 1, further comprising recovering lithium.

21. A method of processing brine comprising lithium, the method comprising
providing a feed brine and a draw brine to a forward osmosis (FO) module, and forming a feed brine concentrate and a dilute draw brine,
the feed brine and draw brine being substantially free of make-up water, make-up aqueous solutions, or combinations thereof, and
the draw brine comprising lithium;
providing the dilute draw brine to a first nanofiltration (NF) module, operating the first NF module at a pressure of at least 800 psi or at maximum 1600 psi, and forming a first NF permeate;
providing the first NF permeate to a second NF module, and forming a second NF permeate; and
recovering lithium from the second NF permeate.

22. (canceled)

23. A method of processing brine comprising lithium, the method comprising
providing a first brine to an initial NF module, operating the initial NF module at a pressure between about 130 psi to about 1500 or 1600 psi, and forming an initial NF permeate,
the first brine comprising lithium and being substantially free of make-up water, make-up aqueous solutions, or combinations thereof;
providing to a first FO module a draw brine and the initial NF permeate as a feed brine, and forming a feed brine concentrate and a dilute draw brine,
the draw brine comprising lithium and being substantially free of make-up water, make-up aqueous solutions, or combinations thereof;
providing the dilute draw brine to a first nanofiltration (NF) module, operating the first NF module at a pressure of at least 800 psi or at maximum 1600 psi, and forming a first NF permeate; and
recovering lithium from the first NF permeate and/or the feed brine concentrate.

24-31. (canceled)
